(19) United States
(12) Patent Application Publication
(10) Pub. No.: US 2026/0228613 A1
(43) Pub. Date: Aug. 6, 2026

(54) DYNAMIC HUMAN-IN-THE-LOOP AGENT TRAINING

(71) Applicant: Epic Games, Inc., Cary, NC (US)

(72) Inventors: Nathan Martz, San Francisco, CA (US); Stewart Miles, San Francisco, CA (US); Leopold Haller, San Francisco, CA (US); Isaac Neal, San Francisco, CA (US); Batu Aytemiz, San Francisco, CA (US); Max De Jong, San Francisco, CA (US)

(73) Assignee: Epic Games, Inc., Cary, NC (US)

(21) Appl. No.: 19/047,453

(22) Filed: Feb. 6, 2025

(51) Int. Cl. G06N 20/00; A63F 13/40

(52) U.S. Cl. CPC G06N 20/00; A63F 13/40

(57) ABSTRACT

A system for agent training may receive one or more tasks for a character to complete in one or more training sessions of an environment, where the character is controlled by a player that is selectable between a human user and an agent implementing an active model. The system may dynamically switch the player between the human user and the agent during the training sessions, where at least one condition for switching the player is based on an introspection metric associated with at least one of a confidence of the agent or observed actions when the player is the human user. The system may further capture observations from the character in the environment and corresponding actions of the character in the environment from the player during the training sessions as experience data, and train one or more models for the agent based on the experience data.

### TECHNICAL FIELD

The subject matter disclosed herein relates to generative software and, in particular, training and optimizing generative agents.

### BACKGROUND

In the domain of artificial intelligence (AI) agent training and deployment, as well as generative software development more generally, current advancements face notable challenges associated with costs and operational complexities. These challenges arise from the need for specialized neural network architectures, extensive training datasets, effective monitoring and optimization mechanisms, and the ability to track and version artifacts generating by agents.

For example, two primary costs are evident when deploying a neural network as an agent. The first is the labor-intensive task of constructing a neural network architecture tailored to specific tasks in a specific environment, which requires considerable human expertise and often limits accessibility to machine learning professionals. The second involves generating sufficiently large training datasets to provide a desired level of performance, which often necessitates executing multiple instances of virtual environments or procuring physical entities like robots and thus introduces substantial capital costs and operational complexities.

Additionally, the quality and diversity of training data significantly impact the performance and adaptability of trained models. While human-generated data provides rich insights into real-world scenarios, it is costly and time-consuming to collect. AI-generated data, on the other hand, can be produced at scale and lower cost but may lack the depth of human-generated data. Existing systems often follow a sequential approach, using human data for initial training and then relying on AI-generated data for subsequent iterations. This separation limits human intervention during critical training moments and may result in biased or incomplete training sets, restricting the model's ability to generalize to diverse scenarios and adapt to new environments.

Understanding and analyzing agent behavior is crucial for optimizing performance and debugging issues, but presents additional challenges. Once trained, AI agents can be deployed to perform various tasks, such as identifying bugs in simulations or providing live teammates for characters in video games. However, these deployments frequently occur in environments where direct human observation is impractical, such as overnight operations or remote datacenters. This lack of direct oversight poses significant challenges in analyzing, debugging, and comprehending the actions of deployed agents. Traditional methods for monitoring and analyzing agent behavior rely on logs and indirect data, which can be cumbersome and insufficient for gaining a comprehensive understanding of the agents' actions and decisions. Without real-time, detailed visualization, accurately interpreting the spatial and temporal context of the agents' activities is difficult.

Version control for generative software such as neural networks or code written by neural networks presents further challenges. In generative software development, ensuring effective version control, comprehensive telemetry, and robust optimization is essential for maintaining and improving system performance. Generative software, which samples non-deterministically from distributions during execution, presents unique challenges that traditional software engineering systems and methodologies struggle to address. Traditional version control systems like Git or SVN, combined with rudimentary logging mechanisms, offer basic support for managing code changes and capturing execution data. However, they lack the specialized capabilities needed to handle the intricacies of generative software. These systems do not provide the fine-grained execution data necessary for detailed performance profiling and optimization, making it difficult to identify and address bottlenecks. Furthermore, debugging generative software is often a manual and time-consuming process, hindering the ability to quickly iterate and improve system performance.

Therefore, it is desirable to provide systems and methods that address the deficiencies of the previous approaches identified above.

### SUMMARY

In embodiments, the techniques described herein relate to a system including a controller including one or more processors configured to execute program instructions stored in a memory medium causing the one or more processors to receive one or more tasks for a character to complete in one or more training sessions of an environment, where the character is controlled by a player, where the player is selectable between a human user and an agent implementing an active model by the controller; dynamically switch the player between the human user and the agent during the one or more training sessions, where at least one condition for switching the player is based on an introspection metric generated by the agent, where the introspection metric is associated with at least one of a confidence of the agent or observed actions when the player is the human user; capture observations from the character in the environment and corresponding actions of the character in the environment from the player during the one or more training sessions as experience data; and train one or more models for the agent based on the experience data, where the one or more models includes the active model.

In embodiments, the techniques described herein relate to a system, where the agent generates candidate actions based on the observations of the character in the environment when the human user is the player, where the introspection metric includes a surprise metric associated with a difference between the candidate actions and actions of the human user.

In embodiments, the techniques described herein relate to a system, where the introspection metric includes an uncertainty metric associated with a confidence of actions by the agent when the agent is the player.

In embodiments, the techniques described herein relate to a system, where at least one condition for switching the player is based on a signal from the human user requesting control when the agent is the player.

In embodiments, the techniques described herein relate to a system, where training a particular one of the one or more models for the agent includes assigning weights for the one or more training sessions associated with a particular model of the one or more models to provide weighted experience data; and training the particular model based on the weighted experience data.

In embodiments, the techniques described herein relate to a system, where the program instructions are configured to evaluate the one or more models based on one or more quality metrics; and select the active model for the agent based on the one or more quality metrics.

In embodiments, the techniques described herein relate to a system, where the one or more quality metrics include an estimated probability that a particular one or the one or more models could successfully complete the one or more tasks.

In embodiments, the techniques described herein relate to a system, where the one or more quality metrics include an estimated probability that a particular one or the one or more models could successfully complete the one or more tasks.

In embodiments, the techniques described herein relate to a system, where evaluating the one or more models based on the one or more quality metrics includes using a multi-armed bandit algorithm to determine the estimated probability that the particular one or the one or more models could successfully complete the one or more tasks.

In embodiments, the techniques described herein relate to a system, where a particular one of the one or more training sessions terminates upon at least one of a successful completion of the one or more tasks, a failure to complete the one or more tasks, or a termination request by the human user.

In embodiments, the techniques described herein relate to a system, where at least one of the observations or actions available to the player in the environment are limited to a parameter space selected by the human user from a candidate set of parameters.

In embodiments, the techniques described herein relate to a system, where the parameter space includes one or more properties of the character.

In embodiments, the techniques described herein relate to a system, where the parameter space includes at least one of a presence of one or more entities in the environment or properties of the one or more entities.

In embodiments, the techniques described herein relate to a system, where the parameter space further includes sensory feelers defining at least one of a spatial range, a temporal range, or a sensitivity of at least some observations available to the character in the environment.

In embodiments, the techniques described herein relate to a system, where training one or more models for the agent based on the experience data further includes converting the observations to an egocentric frame of reference of the character.

In embodiments, the techniques described herein relate to a system, where the agent further includes a pre-processor configured to pre-process the observations to an environment independent form.

In embodiments, the techniques described herein relate to a system, where pre-processing the observations to the environment independent form includes pre-processing distances in the observations using a distance-based normalization technique.

In embodiments, the techniques described herein relate to a method including receiving one or more tasks for a character to complete in one or more training sessions of an environment, where the character is controlled by a player, where the player is selectable between a human user and an agent implementing an active model; dynamically switching the player between the human user and the agent during the one or more training sessions, where at least one condition for switching the player is based on an introspection metric generated by the agent, where the introspection metric is associated with at least one of a confidence of the agent or observed actions when the player is the human user; capturing observations from the character in the environment and corresponding actions of the character in the environment from the player during the one or more training sessions as experience data; and training one or more models for the agent based on the experience data, where the one or more models includes the active model.

In embodiments, the techniques described herein relate to a method, where the agent generates candidate actions based on the observations of the character in the environment when the human user is the player, where the introspection metric includes a surprise metric associated with a difference between the candidate actions and actions of the human user.

In embodiments, the techniques described herein relate to a method, where the introspection metric includes an uncertainty metric associated with a confidence of actions by the agent when the agent is the player.

In embodiments, the techniques described herein relate to a method, where at least one condition for switching the player is based on a signal from the human user requesting control when the agent is the player.

In embodiments, the techniques described herein relate to a method, where training a particular model of the one or more models for the agent includes assigning weights for the one or more training sessions associated with the particular model to provide weighted experience data; and training the particular model based on the weighted experience data.

In embodiments, the techniques described herein relate to a method, further including evaluating the one or more models based on one or more quality metrics; and selecting the active model for the agent based on the one or more quality metrics.

In embodiments, the techniques described herein relate to a method, where the one or more quality metrics include an estimated probability that a particular one or the one or more models could successfully complete the one or more tasks associated with the one or more training experiences.

In embodiments, the techniques described herein relate to a method, where the one or more quality metrics include an estimated probability that a particular one or the one or more models could successfully complete the one or more tasks.

In embodiments, the techniques described herein relate to a method, where evaluating the one or more models based on one or more quality metrics includes using a multi-armed bandit algorithm to determine the estimated probability that the particular one or the one or more models could successfully complete the one or more tasks.

In embodiments, the techniques described herein relate to a method, where a particular one of the one or more training sessions terminates upon at least one of a successful completion of the one or more tasks, a failure to complete the one or more tasks, or a termination request by the human user.

In embodiments, the techniques described herein relate to a method, where at least one of the observations or actions available to the player in the environment are limited to a parameter space selected by the human user from a predefined candidate set of parameters.

In embodiments, the techniques described herein relate to a method, where the observations available to the character include one or more properties of the character.

In embodiments, the techniques described herein relate to a method, where the parameter space includes at least one of a presence of one or more entities in the environment or properties of the one or more entities.

In embodiments, the techniques described herein relate to a method, where the parameter space further includes sensory feelers defining at least one of a spatial range, a temporal range, or a sensitivity of at least some observations available to the character in the environment.

In embodiments, the techniques described herein relate to a method, where training one or more models for the agent based on the experience data further includes converting the observations from the environment to an egocentric frame of reference of the character.

In embodiments, the techniques described herein relate to a method, where the agent further includes a pre-processor configured to pre-process the observations to an environment independent form.

In embodiments, the techniques described herein relate to a method, where pre-processing the observations to the environment independent form includes pre-processing distances in the observations using a distance-based normalization technique.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### DESCRIPTION OF THE DRAWINGS

The numerous advantages of the disclosure may be better understood by those skilled in the art by reference to the accompanying figures.

FIG. 1 illustrates a simplified schematic of an agent deployment system, in accordance with one or more embodiments of the present disclosure.

FIG. 2 illustrates a flow diagram of a method for deploying a customizable agent, in accordance with one or more embodiments of the present disclosure.

FIG. 3 illustrates interactions between an environment and a character that may interact with the environment, in accordance with one or more embodiments of the present disclosure.

FIG. 4A illustrates non-limiting portions of a graphical user interface (GUI) for defining various observations available to a customized agent, in accordance with one or more embodiments of the present disclosure.

FIG. 4B illustrates non-limiting portions of a GUI for defining various actions available to a customized agent, in accordance with one or more embodiments of the present disclosure.

FIG. 5 illustrates a simplified schematic of an agent including an agent model, a pre-processor, and a post-processor, in accordance with one or more embodiments of the present disclosure.

FIG. 6 illustrates a simplified schematic of the operation of a customized agent, in accordance with one or more embodiments of the present disclosure.

FIG. 7 illustrates a flow chart of a training process implemented by the agent deployment system, in accordance with one or more embodiments of the present disclosure.

FIG. 8 illustrates flow diagram of a method of training agents to complete tasks in an environment by integrating human and agent training data together.

FIG. 9 illustrates a flow diagram of a training process capable of switching between human and agent control of a character, in accordance with one or more embodiments of the present disclosure.

FIGS. 10A-10B illustrate flow diagrams of a process of collecting training data from a human character.

FIGS. 11A-11B illustrate flow diagrams of a process of collecting training data from an agent character.

FIG. 12 illustrates flow diagram of a trainer service, in accordance with one or more embodiments of the present disclosure.

FIG. 13 illustrates the process of trajectory amplification, in accordance with one or more embodiments of the present disclosure.

FIG. 14 illustrates a flow diagram for selecting the active model for an agent, in accordance with one or more embodiments of the present disclosure.

FIG. 15 illustrates a flow chart for a method for synchronizing and displaying multiple data streams into a unified time stream associated with one or more characters within the environment, in accordance with one or more embodiments of the present disclosure.

FIG. 16 illustrates a simplified schematic of synchronizing multiple data streams into a unified time stream, in accordance with one or more embodiments of the present disclosure.

FIG. 17 illustrates a simplified schematic displaying the unified time stream through an interactive interface on a display device, in accordance with one or more embodiments of the present disclosure.

FIG. 18 illustrates an interactive interface allowing a user to control visualization of desired portions of the unified time steam, in accordance with one or more embodiments of the present disclosure.

FIGS. 19A-19B illustrates the method of executing versioned snapshots, execution telemetry and optimization of the customized agent, in accordance with one or more embodiments of the present disclosure.

FIG. 20 illustrates a flow diagram of operation of nested software components, in accordance with one or more embodiments of the present disclosure.

FIG. 21 illustrates versioning of nested software components, in accordance with one or more embodiments of the present disclosure.

FIG. 22 illustrates a schematic providing execution of any version of the previously documented executions by accessing a store and checking out the snapshots, in accordance with one or more embodiments of the present disclosure.

FIG. 23 illustrates rewind and replay of snapshots, in accordance with one or more embodiments of the present disclosure.

FIG. 24 illustrates an execution tree with multiple execution replays, in accordance with one or more embodiments of the present disclosure.

FIG. 25 illustrates a scenario involving human user input and an asynchronous execution, in accordance with one or more embodiments of the present disclosure.

FIG. 26 illustrates a gradient-free optimization technique, in accordance with one or more embodiments of the present disclosure.

FIG. 27 illustrates an example of the operation of a genetic algorithm for generative programs, in accordance with one or more embodiments of the present disclosure.

FIG. 28 illustrates gradient-based optimization with a supervised fine-tuning approach, in accordance with one or more embodiments of the present disclosure.

FIG. 29 illustrates a flow diagram depicting high-order optimization, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods for generating, training, visualizing, and versioning customized software agents for operation in a specific environment. The environment may be a virtual environment (e.g., a game or other simulated environment) or a physical environment. As used herein, the terms agent, software agent and AI agent are used interchangeably to refer to an executable package that may receive inputs from an environment and take actions within the environment. In many cases, an agent may be designed to operate in accordance with one or more objectives in the environment.

A comprehensive framework is provided herein for generating and refining customized agents suitable for use in a specific environment.

In embodiments, a feature space for an agent is defined for a specific environment, which may define the interactions between the agent and the environment. For example, the feature space may include an observation space defining a set of observations (e.g., inputs) that the agent may receive from the environment and an action space defining set of actions that the agent may take within the environment. This feature space may include only a subset of possible observations or actions supported by the environment, which may tailor the operation of the agent, reduce training requirements, provide agent focus, limit erratic behavior or hallucinations, and promote stable operation. The feature space may be defined using any suitable technique by any combination of human or software input. In some embodiments, the feature space is defined by a user, either through a graphical user interface (GUI) or manual coding. It is contemplated herein that defining a feature space of an agent via a GUI may substantially reduce the level of expertise required by the user and may thus make operation of the system accessible to a wide variety of users.

In embodiments, an agent is constructed based on the feature space. Various architectures are contemplated herein for an agent. In some embodiments, an agent includes a neural network, which may be trained based on training data generated from humans or agents (e.g., the agent itself and/or agents). In some embodiments, an agent includes an application programming interface (API) for interacting with the environment based on the feature space, a generative coding model suitable for generating code based on the API, and executable code generated by the generative coding model. For example, the API may define techniques for processing observations within the observation space (e.g., mathematical operations, or the like) and/or defining various types of actions including single actions, simultaneous actions, or asynchronous actions. In this way, the executable code generated by the generative coding model may interface with the API instead of the environment directly. Any type of generative coding model may be utilized including, but not limited to, a large language model (LLM).

In embodiments, the agent may be refined by operating the agent in the environment with human interaction through human-in-the-loop (HIL) techniques. The type of human interaction may depend on the architecture of the agent. Further, this refinement may be performed through real-time iterations with a human operator. For example, a real-time HIL technique may respond to human interaction while an agent is operating in an environment, where any changes to the agent may be implemented on the fly. As used herein, the term real-time refers to operations that occur within a selected timeframe. Any selected timeframe may be used such as, but not limited to, less than 30 seconds, less than 10 seconds, less than 1 second, or less than one millisecond. Such an approach enables rapid and efficient refinement of an agent based on human observations and input.

For example, when the agent includes a neural network, this neural network may be trained using a combination of agent-generated training data and human-generated training data, where the agent-generated training data is generated when the agent is operating in the environment as the character and the human-generated training data is generated when a human is operating in the environment as the character. In some embodiments, the agent deployment system provides for dynamic switching between human and agent operation of a character (e.g., switching between a human player of the character and an agent player of the character) in the environment, which may provide efficient training in real time. This switching may be manually triggered by a human (e.g., by a human requesting control) or may be triggered based on introspection metrics generated by the agent. For example, the agent may generate a surprise metric when observing a human operating as the character that is associated with a difference between actions performed by the human operator and actions suggested by the agent. As another example, the agent may generate an uncertainty metric when operating as the character associated with a confidence of suggested actions.

As another example, when the agent includes an API and a generative coding model, the executable code used when the agent is operating in the environment may be updated through human interaction with the generative coding model. For example, a human may observe the operation of the agent in the environment and provide new instructions to the generative coding model to update the executable code. Like with the neural network approach above, this operation can be done in real time to provide efficient refinement of the agent (e.g., efficient refinement of the executable code).

In embodiments, the present disclosure introduces an interactive visualization system for spatial telemetry and video data. This system addresses the challenges of analyzing and debugging AI agents deployed in environments where direct human observation may be impractical, such as overnight operations or remote datacenters. By presenting spatial telemetry in 2D and 3D formats synchronized with video captured from the environment, the system can provide a comprehensive understanding of agent performance. This approach may significantly reduce the time required to inspect both individual and aggregate agent behaviors, making it easier to analyze, debug, and understand agent activities. This system may further blend trajectory data associated with human operation of the character and agent operation of the character for efficient evaluation of the entire process.

In embodiments, a system is provided for versioned storage, telemetry, and optimization of generative software applications. The terms generative software and generative computational modules are used interchangeably herein and refer to code that may be executed by one or more processors that performs generative functions. This system streamlines the development, maintenance, and optimization of generative software by incorporating versioned storage, detailed execution telemetry, and advanced optimization techniques. It captures immutable snapshots of software components and their execution history, supports flexible execution workflows, and leverages automated optimization methods to enhance performance. This robust framework addresses the unique challenges of managing and optimizing generative software, enabling efficient and effective software development.

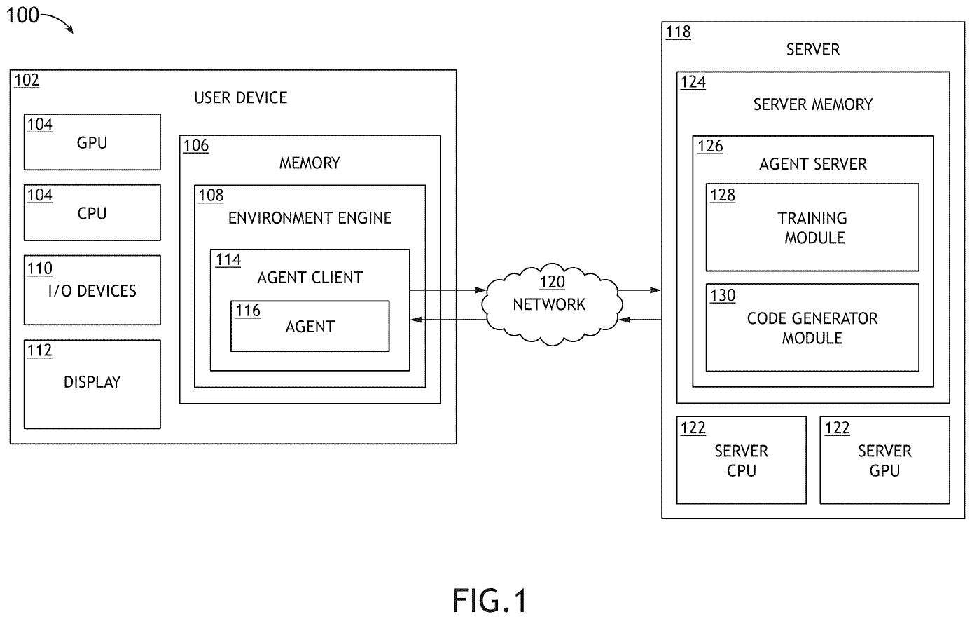

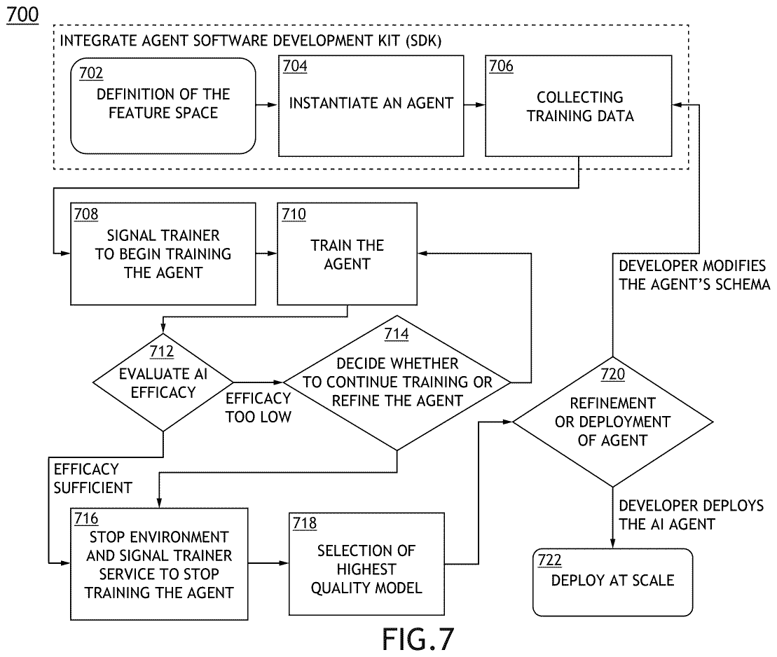

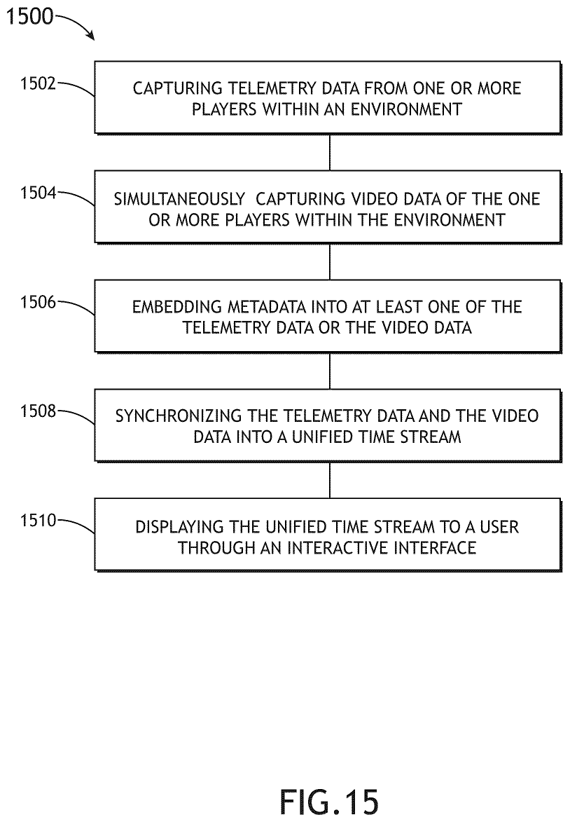

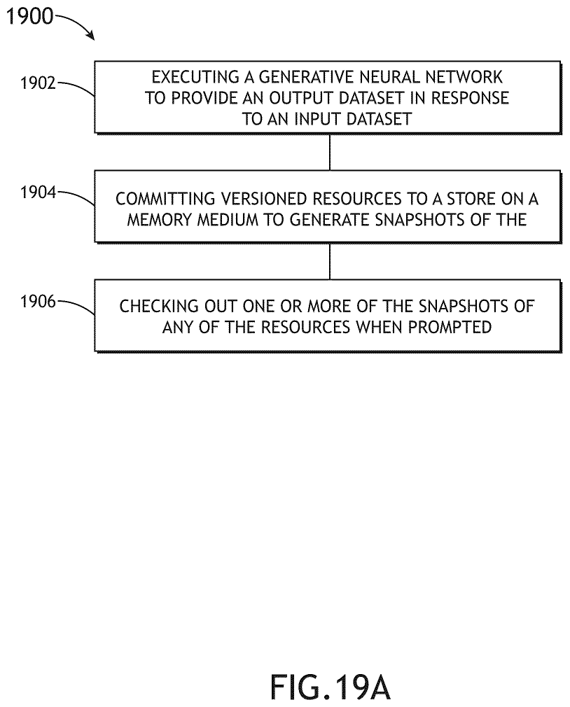

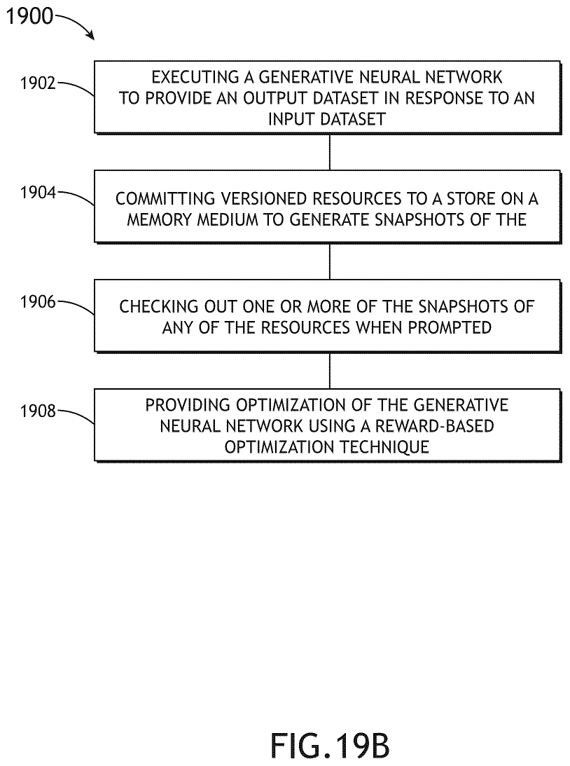

Referring now to FIGS. 1-29, systems and methods for constructing, refining, versioning, and deploying customized agents are described, in accordance with one or more embodiments of the present disclosure. In particular, FIGS. 1-6 depict generating AI agents, FIGS. 7-14 depict training agents by integrating human and autonomous learning, FIGS. 15-18 depict visualizing agent telemetry, and FIGS. 19-29 depict optimizing generative software applications.

FIG. 1 illustrates a simplified schematic of an agent deployment system 100, in accordance with one or more embodiments of the present disclosure. The agent deployment system 100 may be suitable for generating, customizing and training AI agents within an environment.

In some embodiments, an agent deployment system 100 includes a user device 102 including one or more processors 104 configured to execute program instructions stored on a memory medium 106. In this way, the program instructions can cause the processors 104 to implement any of the various steps or actions described herein either directly or indirectly by directing other components to implement any of the various steps or actions.

The one or more processors 104 may include any type of processor capable of retrieving program instructions stored in the memory medium 106 and executing the program instructions. For the purposes of the present disclosure, the term “processor” or “processing element” may be broadly defined to encompass any device having one or more processing or logic elements including, but not limited to, central processing units (CPUs), graphical processing units (GPUs), integrated circuit (ASIC) devices, field programmable gate arrays (FPGAs), or one or more digital signal processors (DSPs)). For example, FIG. 1 depicts the one or more processors 104 as including one or more CPUs and/or one or more GPUs. The user device 102 may include any computing device compatible with the one or more processors 104. For example, the user device 102 may be a personal computer (PC), mainframe computer system, workstation, networked computer, tablet, or the like.

The memory medium 106 may include any storage medium known in the art suitable for storing program instructions executable by the associated one or more processors 104. For example, the memory medium 106 may include a non-transitory memory medium. By way of another example, the memory medium 106 may include, but is not limited to, a read-only memory (ROM), a random-access memory (RAM), a magnetic or optical memory device (e.g., disk), a magnetic tape, a solid-state drive and the like.

The memory medium 106 may be housed in a common controller housing with the one or more processors 104. In one embodiment, the memory medium 106 may be located remotely with respect to the physical location of the one or more processors 104. For instance, the one or more processors 104 may access a remote memory (e.g., server), accessible through a network (e.g., internet, intranet and the like). Further, the processors 104 and memory medium 106 may be enclosed in a single housing or multiple housings. In this way the processors 104 and/or memory medium 106 may provide distributed and/or parallel execution of tasks.

The user device 102 may be configured to store and implement an environment engine 108 that enables a character to interact with an environment by providing observables related to the environment to the character and implements actions of the character to the environment. The environment engine 108 may be suitable for interfacing a character with any type of environment including, but not limited to, a virtual environment, a simulated environment, an augmented environment (e.g., an augmented reality environment), or a physical environment. In some embodiments, the environment engine 108 may include a game engine (e.g., Unity 3D, Unreal Engine, a C++ engine, or the like). In some embodiments, the one or more processors 104 may execute instructions (e.g., program instructions) associated with the environment engine 108 to generate the environment or portions of the environment.

The user device 102 may support one or more characters that may interact with or within the environment via the environment engine 108. A character may make or receive observations associated with the environment (or objects therein) and may take actions within the environment. As an illustration, a character may be represented as an avatar or object within the virtual environment that may interact with other avatars or objects within the virtual environment. The character may be controlled by a human operator (e.g. a user) and/or an agent (e.g., a software agent).

In some embodiments, the user device 102 includes one or more input/output (I/O) devices 110 to provide a human/machine interface (HMI). An I/O device 110 may include any component or combination of components providing a HMI such as, but not limited to, a keyboard, a mouse, a joystick, a touchscreen, a gaming controller, a virtual reality (VR) headset, an augmented reality (AR) headset, a microphone, a gyroscope, or the like. The user device 102 may also include a display 112, such as a monitor or a screen. In some cases, an I/O device operates as a display 112. For example, a VR headset or an AR headset may operate both as an I/O device 110 and a display 112.

The I/O devices 110 and/or the display 112 may enable a human user to interact with the environment via the environment engine 108. For example, the environment engine 108 may provide data suitable for visualizing the virtual environment (and/or objects therein) on the display 112 and may further accept input from the human through the one or more I/O devices 110.

In some embodiments, the user device 102 includes an agent client 114 suitable for implementing one or more agents 116 in the environment. For example, the agent client 114 may relay information from the environment engine 108 (e.g., observations) to an agent 116 as well as relay intended actions provided by the agent 116 to the environment engine 108 so that they may be effectuated in the environment. In this way, the environment engine 108 may interchangeably interface with a character operated by a human via the I/O devices 110 or an agent 116 via the agent client 114.

Further, the agent client 114 may interact with multiple agents 116 or instances thereof. For example, the agent deployment system 100 may support the simultaneous and/or sequential generation of multiple agents 116 having different variations and/or versioned instances. Accordingly, the agent client 114 may implement any particular agent 116 at any point in time. In some cases, the agent client 114 may switch agents in real time (e.g., on the fly)

The operations of the agent deployment system 100 may be performed exclusively on a user device 102 or may be distributed between the user device 102 and one or more servers 118.

For example, it may be desirable to distribute tasks such as, but not limited to agent training or storage to one or more servers. FIG. 1 depicts a configuration in which the agent deployment system 100 includes a server 118 connected to a user device 102 via a network 120. The network 120 may include any type of communication channel including, but not limited to, local area network (LAN) or an internet connection channel. In this way, the servers 118 may be placed in any suitable location.

In FIG. 1, a server 118 includes one or more server processors 122 configured to execute program instructions stored on a server memory 124. As with the user device 102, the server processors 122 may include any type of processing device known in the art suitable for executing program instructions stored on the server memory 124. For example, FIG. 1 depicts a CPU and a GPU as server processors 122.

FIG. 1 further depicts an agent server 126 that may execute one or more modules that operate on agents 116. For example, FIG. 1 depicts a training module 128 that may train one or more agents 116 (e.g., agents 116 including neural networks) with training data. For example, the agent client 114 may collect observations from the environment and send them to the agent server 126. The agent server 126 may process the observations to generate and train an agent 116. As another example, FIG. 1 depicts a code generator module 130 that may execute a generative coding model (e.g., an LLM, or the like) to create executable code for an agent 116 based on an API.

It is noted, however, that although FIG. 1 depicts a single server 118, this is merely an illustration and not limiting on the scope of the present disclosure. In some embodiments, the agent deployment system 100 has a multi-tenant configuration in which one or more user devices 102 are connected to one or more servers 118.

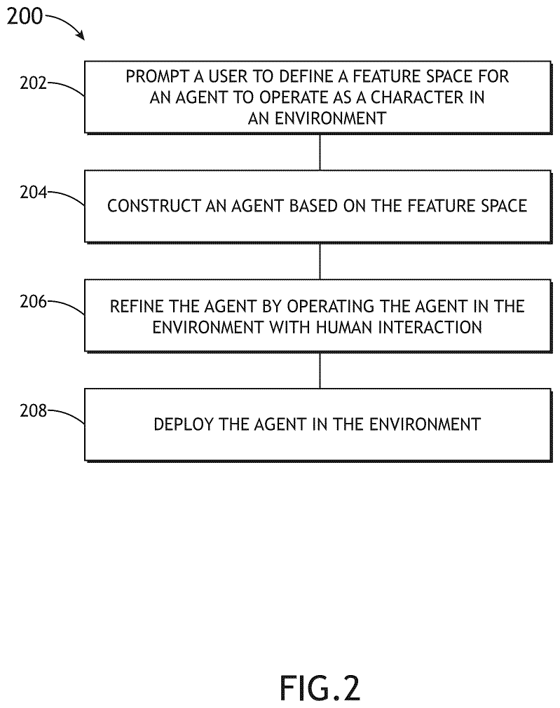

Referring now to FIGS. 2-7, the generation of a customized agent is described in greater detail, in accordance with one or more embodiments of the present disclosure.

FIG. 2 illustrates a flow diagram of a method 200 for deploying a customizable agent, in accordance with one or more embodiments of the present disclosure.

In some embodiments, the method 200 includes a step 202 of prompting a user to define a feature space for an agent 116 to operate as a character in an environment. The feature space may include an observation space available to the agent 116 in the environment and an action space available to the agent in the environment.

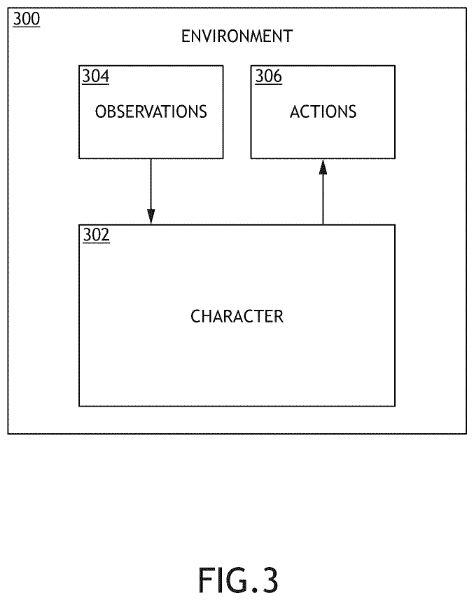

FIG. 3 illustrates interactions between an environment 300 and a character 302 that may interact with the environment 300, in accordance with one or more embodiments of the present disclosure. As described previously herein, the character 302 may be a human or a customized agent (e.g., software agent) as disclosed herein. Further, the character 302 may alternate between humans and agents at any point.

The environment 300 may define various observations 304 that may be available to a character 302 such as, but not limited to, objects, other characters (e.g., non-playable characters, other playable characters, or the like), properties of objects and/or characters, or any other parameter expressed in the environment 300. The nature of the objects, characters, properties, or parameters may depend on the nature of the environment (e.g., whether the environment 300 is virtual, physical, augmented, or the like).

For example, objects may include a ground surface, trees, plants, water features, buildings, cars, or items. Nonlimiting examples of properties include properties of objects such as, color, weight, whether the object is moveable, or whether the object may be acquired by the character. Additional nonlimiting examples of properties include attributes of characters such as, but not limited to, health, currency, inventory, or status (e.g., friend, enemy, neutral, or any other status indicator).

The observations 304 may be presented to the character 302 in any format. For example, some observations may be visible in a video stream available to the character 302. As another example, the observations 304 may be made available to the character as data through spatial sensors, referred to herein as feelers. For instance, a feeler may scan the surroundings of the character for detectable observations. In some cases, a feeler may be spatially limited such that only properties of the environment 300 within certain distances and/or directions in the environment 300 are detectable. As an illustration, feelers may define a field of view of a character 302 and potential distance limits for observations 304.

The environment 300 may also define actions 306 available to the character 302. For example, actions may include, but is not limited to, changing an orientation of the character 302 (e.g., looking within a particular direction), moving the character 302, picking up an object, putting an object down, selecting an item from an inventory, shooting a weapon, or engaging with a character.

The actions 306 available to a character 302 may be mapped or mappable to controls that may be accessed by I/O devices 110 and/or an agent client 114 such as, but not limited to, button presses, keystrokes, mouse movements, mouse clicks, joystick movements, actions in a virtual reality controller, or the like).

Referring again to FIG. 2, the step 202 may include prompting the user to define an observation space including a selected set of observations 304 for an agent 116 to consider and/or an action space including a selected set of actions that an agent 116 may perform in the environment 300. In some cases, the observation space and/or the action space represents a subset of possible observations and/or actions made available by the environment. In this way, the feature space defined in step 202 may be a constrained feature space.

The observation space may include any properties of a character associated with the agent 116 in the environment 300, other entities or objects in the environment 300, or the environment 300 itself. For example, the observation space may include properties such as, but not limited to, presence, health, currency, inventory, visibility, team status, or location of entities, characters, and/or objects in the environment 300. As another example, the observation space may include includes sensory feelers defining at least one of a spatial range, a temporal range, or a sensitivity of at least some of the observations available to the character. Further, in some cases, at least some of the observations in the observation space are weighted by priority.

The action space may include any actions available to the character associated with the agent 116 in the environment 300. For example, the action space may include, but is not limited to, motion of the character or interaction of the character with objects or entities in the environment 300.

It is contemplated herein that defining a feature space in step 202 may enable the creation of a customized agent suitable for performing a specific objective within the environment 300. For example, not every available observation 304 or action 306 may be necessary to achieve a particular purpose or objective. Accordingly, the step 202 may disregard at least some unnecessary and/or undesirable observations 304 or actions 306.

It is further contemplated herein that limiting the observation space and/or the action space when creating a customized agent 116 may provide numerous benefits including, but not limited to, reducing complexity of the agent 116, reducing processing power required to deploy the agent, reducing training requirements (e.g., reducing an amount of training data required to achieve a desired level of performance), reducing erratic behavior or hallucinations, or improving stability. In a general sense, the number and complexity of decisions to be performed by an agent (or a character more generally) scales with the allowable observations and actions. Accordingly, creating a feature space that includes only a subset of observations and/or actions may limit the number and complexity of decisions to be performed by the agent and thus improve performance and stability.

As an illustration in the case of an agent 116 including a neural network, limiting the observation space and/or the action space may enable simplifying an architecture of the neural network (e.g., a number of nodes, layers, or the like) without sacrificing performance. Additionally, the amount of training data required to achieve a desired level of performance may be substantially reduced.

As another illustration in the case of an agent 116 including executable code from a generative coding model, limiting the observation space and/or the action space may simplify the length and complexity of the executable code that needs to be generated, which may improve performance and promote simplified refinement to achieve a desired level of performance.

The user may define a feature space in step 202 using any programmatic interface. In some embodiments, the user may create and/or manipulate one or more files (e.g., configuration files) that define one or more aspects of the feature space. In some embodiments, the agent deployment system 100 provides a graphical user interface (GUI) to the user to facilitate the definition of the feature space.

It is contemplated herein that a GUI may provide a structured input mechanism for defining the observation space and/or the action space. For example, a GUI may provide a structured mechanism for defining how a customized agent 116 may understand or process various data types of categories of information, where different categories may have different relevant parameters. Further, structuring the feature space definition through a GUI may ensure that agent 116 created from any permutation of observations and actions may operate optimally. In some cases, the GUI may be populated with default options that may be suitable for many applications, but may be modified by the user as desired.

As an illustration, a numerical observation (e.g., how much gold does the character have) may be handled differently than a categorical observation (e.g., am I seeing a health pickup or an ammunition pickup?). A GUI may expose various ways for a user to configure the semantic details associated with different observations or categories of observations. For example, the GUI may provide an option to enable or disable certain feature space options using a checkbox, radio button or the like and then prompt the user to define relevant parameters when enabled.

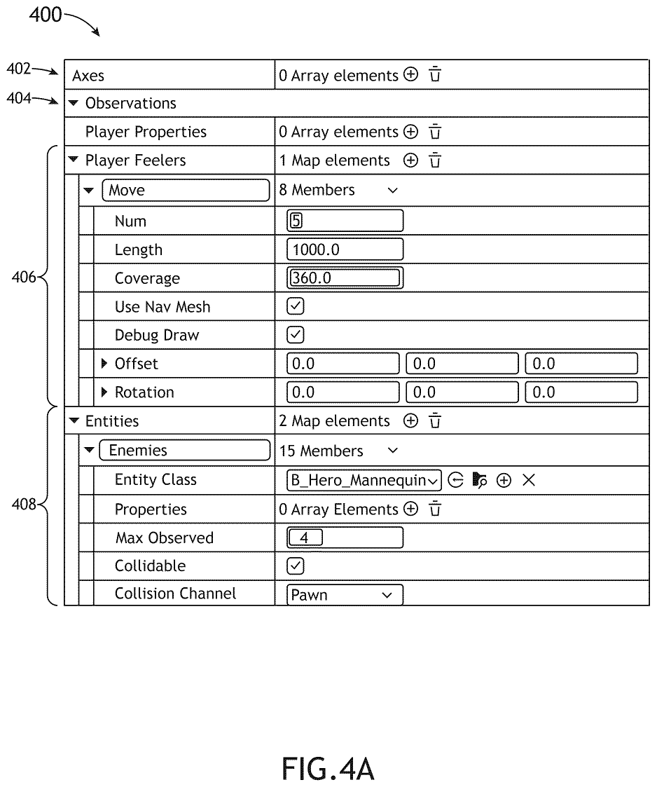

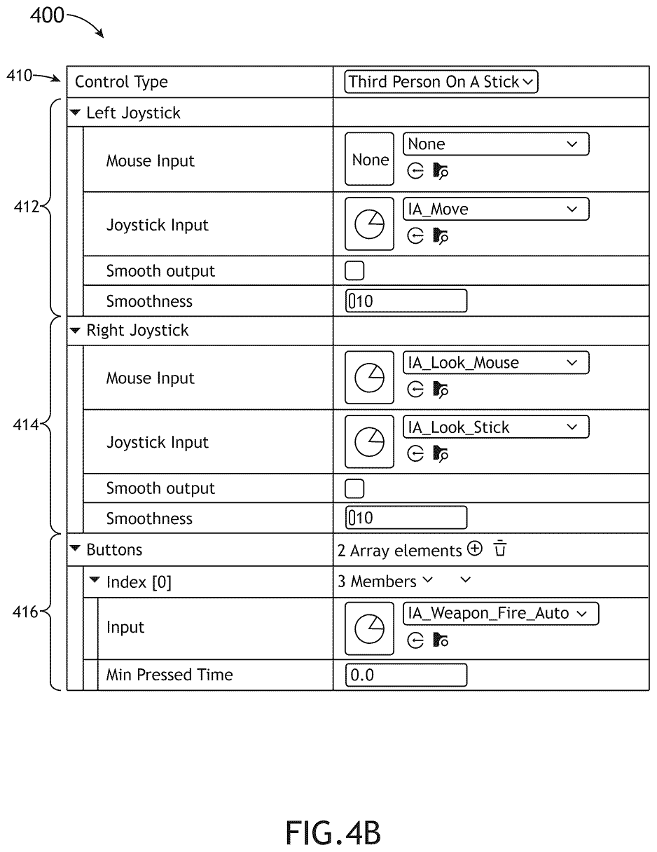

FIGS. 4A-4B illustrate a GUI 400 for defining a feature space, in accordance with one or more embodiments of the present disclosure. In particular, FIG. 4A illustrates a first portion of a GUI 400 and FIG. 4B illustrates a second portion of the GUI 400. In some embodiments, a GUI 400 presents the user with various options relevant to defining the observation space and/or the action space available to the agent 116. The GUI 400 may then receive user input using any type of GUI interfaces such as, but not limited to, check boxes, radio buttons, drop-down menus, or fillable text boxes.

FIG. 4A illustrates non-limiting portions of a GUI 400 for defining various observations available to a customized agent 116, in accordance with one or more embodiments of the present disclosure.

As an illustration, the GUI element 402 allows a user to specify various axes associated with the environment. Here, the axes are defined by array elements, though this is merely an illustration and not limiting.

As another illustration, the GUI element 404 allows a user to specify various character properties associated with the character to be played by the customized agent. Here, the character properties are defined by array elements, though this is merely an illustration and not limiting. Any type of character properties may be available to be selected and/or configured by the user including, but not limited to, physical attributes of the character in the environment, character health, inventory capabilities (e.g., currency, weapons, ammunition, objects, or the like). Further, FIG. 4A depicts a case in which no character properties are yet defined.

As another illustration, the GUI element 406 allows a user to specify various feelers related to the ways by which the customized agent may receive observations in the environment. For example, feelers may be spatial sensors that define or in some cases limit the observability of the customized agent in the environment.

The user may also define the relevant area where observations may occur in the environment. For example, the user may define the properties of the one or more feelers to specify the area of the environment from which observations may be detected. For instance, the length of the feelers may be defined. Since the feelers may only detect observations along their lengths, the agent may only receive observations from within the length of the feelers. The length of the feelers may be defined as a relative distance in the environment. For example, as illustrated in FIG. 4A, the GUI element 406 specifies that the length of the feelers in defined as 1000.

The length of the feelers may be defined to reflect the relevant area around the character, similar to the distance that a human character may be able to view in the environment. For example, the relevant area may be defined to reflect the observations that a human character could detect due to properties of the environment. For instance, the user may define the relevant area via the feelers to account for the render distance used in the environment (e.g., the maximum distance objects in the environment will be displayed). In this regard, by defining the length of the feelers, the user may customize the agent to reflect the observations available to a human character in the environment, constraining observational data to relevant observations.

As another example, the user may define a coverage value to the one or more feelers. The coverage value may be associated with a field of vision to which the feelers may detect observations within. For example, the coverage value may be defined in terms of rotational degrees. For instance, a feeler with a coverage value defined as 360 would be able to detect observations in any direction (e.g., 360°) around the character associated with the feeler. In another instance, a feeler with coverage defined at 180 would only be able to detect observations from within a range of 180° (e.g., in front of the character). For example, as illustrated in FIG. 4A, the GUI element 406 specifies the coverage option as 360.

The user may also optionally choose to define additional features of the feelers. For example, the user may choose to allow the feelers to gather more information about the environment by using functions such a “Nav Mesh” and “Debug Draw”, as illustrated in FIG. 4A. For another example, the user may choose define different configurations of the feelers, such as offsetting, or displacing, the feelers which may change the point of origin of the feeler (e.g., offset the feeler from the character) or rotate the feelers.

As another illustration, the user may define the recognition and identification of entities within the environment. Entities may be any model represented in the environment. The environment may include a variety of classes of entities such as interactive objects, additional characters, NPCs, enemies, or the like. The user may define which entities to include in the set of observations of the feature space. For example, the user may choose for the agent to be able to detect certain classes of entities while ignoring entities of different classes. The user may define which entities to pay attention to by including distinguishing properties of the class (e.g., a character model) in the feature space. The agent may observe the distinguishing property of the entity, and categorically identify it as a member of the class. For example, GUI element 408 may include an entity class option. In this instance, the user has defined the “B_Hero_Mannequin” as the entity class of “Enemies”. As a result, the customized agent may observe and recognize the “B_Hero_Mannequin” in the environment, identifying it as an enemy. The user may further define the additional characteristics of the entities, such as team status, visibility, or the like.

The user may define a maximum number of entities of a particular class that the agent may recognize at a time in an environment. For example, the GUI 400 may include a “Max Observed” box in the “Entities” section of the GUI element 408, where a user may specify the maximum number of entities of the selected class.

The user may also indicate mechanical properties of the class of entities, such as indicating whether the class of the entity is collidable (e.g., does a collision occur when the entity is within a close distance), collision channel (e.g., how does the entity behave after a collision), or the like.

FIG. 4B illustrates non-limiting portions of a GUI 400 for defining various actions available to a customized agent, in accordance with one or more embodiments of the present disclosure.

As an illustration, the GUI element 410 allows the user to specify a control type. For example, the GUI illustrated in FIG. 4B may allow users to define the set of actions by choosing a predefined control mode including character perspective (e.g., a first-person control mode, a third-person control mode, a driving control mode, a piloting control mode, or a platformer control mode) along with the type of control device (e.g., on a stick, on a keyboard) from predetermined list. In this instance, the user has selected “Third Person On A Stick” from a drop down menu in GUI element 410. By selecting the predefined control mode, the user may constrain the actions of the customized agent to those available to a human character in a particular application. The sub-elements 412-416 indicate associated parameters that may be specified for this option.

For example, as illustrated in FIG. 4B, the user may define options under a “Left Joystick” sub-element 412 to select the actions that would be associated with the left joystick on a standard game controller. FIG. 4B illustrates a non-limiting configuration in which a human character may use a game controller having at least a “Left Joystick,” a “Right Joystick,” and “Buttons” (e.g., two buttons here). The GUI 400 thus allows a user in this case to specify actions of the customized agent that map to the “Left Joystick” in sub-element 412, the “Right Joystick” in sub-element 414, and “Button” in sub-element 416.

Referring generally to FIGS. 4A-4B, it is to be understood that the particular depictions of the GUI 400 including the layout, the available options presented to the user, and/or the format of the various GUI elements are provided solely for illustrative purposes and should not be interpreted as limiting the scope of the present disclosure. Rather, the GUI 400 may include any type or arrangement of GUI elements that provide any combination of options to a user for defining a feature space for any type of character in any type of environment.

Referring again to FIG. 2, the method 200 may include a step 204 of constructing an agent 116 based on the feature space.

The agent 116 constructed in step 204 may have any architecture suitable for operating as the character in the environment by receiving observations from the observation space and performing actions from the action space.

In some embodiments, the agent 116 constructed in step 204 includes a neural network. In this configuration, the step 204 may include defining a neural network architecture suitable for operating in the environment based on the feature space defined in step 202. For example, defining the neural network architecture may include selecting architecture parameters such as, but not limited to, a number of layers (including optionally hidden layers), a number of nodes per layer, connections between layers, an activation function, a learning algorithm, hyperparameters, or the like. In some cases, the agent 116 constructed in step 204 includes initial weights for any of the nodes or connections.

In some embodiments, the agent 116 constructed in step 204 includes an API and a generative coding model (e.g., an LLM, or the like) suitable for creating executable code based on the API. In this configuration, the step 204 may include defining the API and/or selecting the generative coding model.

Although it may be feasible in some applications to create code (e.g., via humans and/or a generative coding model) that operates directly on the observations and actions defined in the feature space, it is contemplated herein that defining an API and creating code based on the API may provide superior performance and flexibility. Similar to how neural networks face challenges when learning from limited data, LLMs are not inherently adept at writing detailed game code. However, an API may addresses the aspects of agent programming that an LLM may find difficult such as, but not limited to, 3D mathematics or asynchronous behavior. This allows the LLM to focus on translating human instructions into executable code.

For instance, if a “shoot” action is defined within an action space, the API may enable the specification of the duration of the shooting action based on information provided in step 202, which will simplify the coding required to implement such an action. In a more complex scenario, if the feature space includes definition of an enemy entity as well as “move” and “look at” actions, the API may include functions like “move_to” or “look_at,” which may be directed towards objects or characters such as the enemy. Such API functionality may facilitate ongoing actions such as moving towards and/or looking at the enemy over an extended period of time in the environment. Further, the API may support primitives that combine various actions. For example, to look at and shoot an enemy for three seconds, the API may support a function such as “look_at(observations.enemy).and_also(actions.shoot(3))”. This approach may significantly simplify the coding process compared to writing the underlying control code manually. It is to be understood, however, that these examples are merely illustrative and do not impact the scope of the present disclosure.

In some embodiments, the step 204 includes creating a pre-processor and/or a post-processor to manipulate observations and/or actions on an input side and/or an output side of an agent model (e.g., a neural network, generated code, or the like). In this configuration, the inputs and/or the outputs of the neural network may be linked to the observations/actions by the pre-processor and/or the post-processor. Put another way, a pre-processor and/or a post-processor may correspond to interface layers that allow for further tailoring of the agent model.

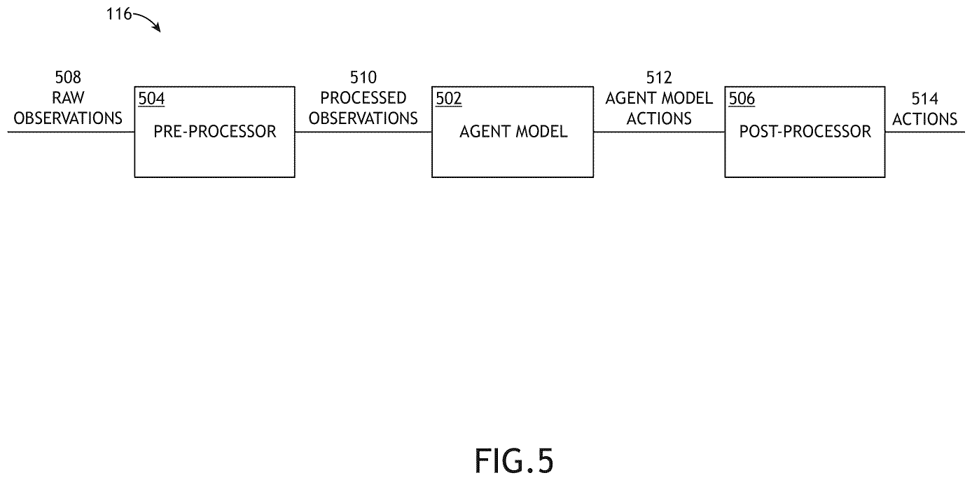

FIG. 5 illustrates a simplified schematic of an agent 116 including an agent model 502, a pre-processor 504, and a post-processor 506, in accordance with one or more embodiments of the present disclosure. In this configuration, the pre-processor 504 may accept raw observations 508 from the environment and provide processed observations 510 to the agent model 502, while the post-processor 506 may accept one or more agent model actions 512 and provide one or more final actions 514 to the environment.

The agent model 502 may include any type of architecture such as, but not limited to, a neural network or an API coupled with a generative coding model. A pre-processor 504 and/or a post-processor 506 may simplify the demands placed on the agent model 502.

For example, a pre-processor 504 may pre-process (e.g., manipulate) observations from an environment-specific format to an environment-independent format, while a post-processor may manipulate observations from an environment-independent format to an environment-specific format. Such a configuration may enable the creation of a relatively general, broadly-applicable, and/or robust agent model 502, where environment-specific features are handled through the pre-processor 504 and/or the post-processor 506. In this way, the agent 116 as a whole may provide a desired level of performance when pursuing a specific objective in a specific environment, but may also be generally capable in a range of objectives or environments that may differ in terms of scale, complexity and/or physical behavior.

As an illustration, a pre-processor 504 and/or a post-processor 506 may provide normalization and scaling functions that allow the agent model 502 to operate on normalized values associated with observations such as, but not limited to distances or sizes. For instance, to account that that different environments may utilize different scales (e.g., a distance of 10 may correspond to 10 meters, 10 feet, or some other unit), the pre-processor 504 may perform distance-based normalization on positional data from observations. The post-processor 506 may then perform the reverse scaling operation. Further, it is to be understood that any property or parameter may be normalized using the pre-processor 504 and/or the post-processor 506 such that the example of distance provide here is merely illustrative and not limiting.

In some embodiments, the pre-processor 504 employs distance-dependent signal sharpening to further process observables provided to the agent model 502. For example, it may be expected in most cases that a character should focus on an entity that the character is looking towards and should focus more on entities that are closest to the character. Accordingly, distance-dependent signal sharpening performed by the pre-processor 504 may include processing feelers using convolutions based on distance from the character to prioritize or sharpen focus of the agent model 502 based on distance and/or field of view. Further, since this process may operate on feelers as defined by the user (e.g., via the GUI 400), this process may leverage the semantics of the agent schema and promote efficient and robust operation.

In some embodiments, the pre-processor 504 performs various operations to increase the quality and efficiency of agent training. For example, the pre-processor 504 may convert spatial observations to an egocentric frame, which may encourage the agent model 502 to learn relatively fundamental and/or generalizable policies, which may promote robust operation and mitigate hallucinations. As another example, the pre-processor 504 may adapt observations in a manner that makes it more difficult to memorize using techniques such as, but not limited to, intentionally introducing (e.g., injecting) dropouts and/or noise, which may also promote robust operation.

In some embodiments, the pre-processor 504 employs spatially-aware entity attention, which may enable the customized agent 116 to operate in complex environments that potentially include many entities. Traditional training methodologies that consider all observable entities equally would require that the amount of training data grow exponentially with the number of entities in the scene. For example, traditional attention mechanisms are formulated over attributes (e.g., health of observable enemies, or the like), which presents a rapidly-increasing number of potential scenarios to an agent as the number of observable entities increases. However, a customized agent 116 may employ spatially-aware entity attention to efficiently learn which entities to pay attention to in a given moment in time and then learn control policies in terms of these important entities. For instance, a spatially-aware attention sub-system may assign an attention score (e.g., a weight) to various observations 304 to influence the degree to which the agent model 502 attends to the observations 304. By decomposing the learning problem this way, spatially-aware entity attention both dramatically reduces the amount of data required to train the customized agent 116 while also helping it learn behaviors that naturally work in a wider range of circumstances.

For example, each attendable entity may be scored or evaluated based on any suitable metric such as, but not limited to, importance, proximity, health status, or the like. A higher score may be associated with an attendable entity that is ranked more important. For instance, an enemy causing damage to a character may receive a higher score when compared to a NPC standing stationary.

Attendable entities may operate on a concatenation of the character query with each entity key. This may be contrasted with dot product scoring typically used in attention systems. Further, the pre-processor 504 may utilize techniques to keep attention sharp and spatially aware when using attention scores. For example, the pre-processor 504 may utilize a low temperature gumbel-softmax distribution to sample attended entities and provide domain-specific mixing of semantically meaningful attributes (e.g., rotation, position, or the like) rather than treating entity attributes as uninterpreted tensors. It is contemplated herein that this technique of sampling and mixing allows for high sharpness in deciding what to pay attention to while also allows optimization of the agent model 502 to proceed unhampered. In particular, the sharpness ensures that the agent model 502 can focus clearly on a given entity at each instant, which avoids a common pitfall of attention systems that tend to hallucinate non-existent entities. The spatial awareness incorporates and preserves important spatial characteristics of the actual entities, allowing the agent model 502 to reason about the selected entities spatially, in the same manner as the raw input entities.

In some embodiments, the pre-processor 504 and/or the post-processor 506 utilize mathematical and algorithmic techniques to allow the agent model 502 to robustly learn from arbitrary observations and produce a heterogenous distribution of actions while maintaining efficient operation.

The ultimate job of the customized agent 116 is to determine what actions to take given a specific set of observations. In deep learning systems (e.g., the agent model 502 including a neural network), there is a complex interplay between the way these actions are modeled mathematically (continuous vs discrete distributions) and other aspects of the learning system (like the relative scales of losses, sizes of gradients, etc). Traditional systems work around these problems by enforcing a single representation of actions and/or tuning hyper parameters for each environment. However, this is inefficient and often requires a tremendous amount of training data. Further, traditional systems may suffer from an inability to consider and properly train for different actions and may thus learn one action at the expense of others. As an illustration, traditional systems providing a first-person agent may train for movement throughout an environment, but may be less well trained on actions such as aiming or shooting and thus struggle when multiple types of actions must be performed simultaneously.

Accordingly, in some embodiments, the agent model 502 is designed and/or trained to provide a heterogenous distribution of actions 512 in response to observations, where the post-processor 506 provides parameterization of the distribution of actions to provide an output action or sequence of actions. For example, the post-processor 506 may perform aleatoric bounded loss scaling, which uses the standard deviation of possible actions to normalize the loss and provide the output action or sequence of actions.

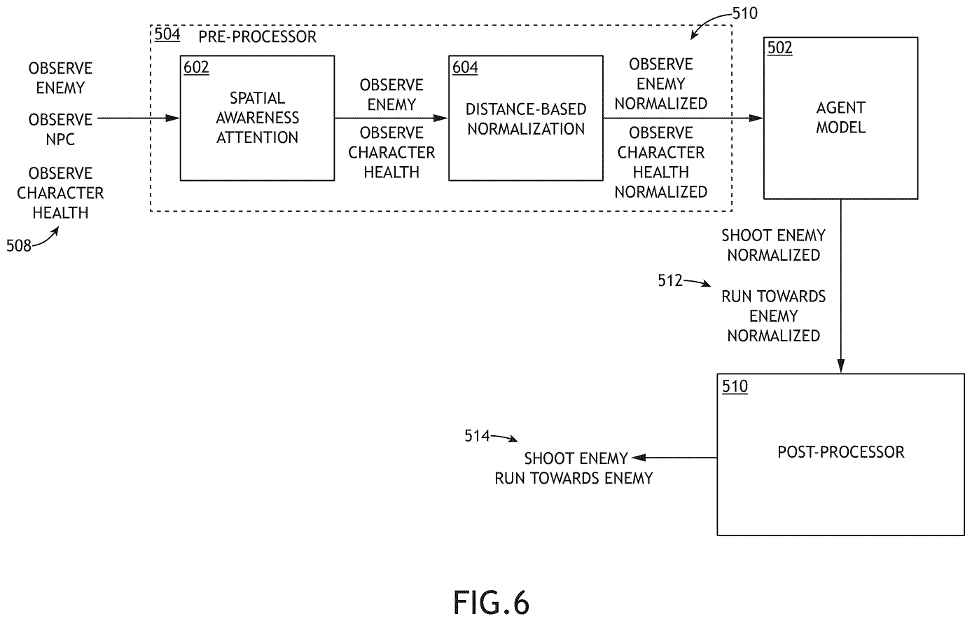

For a non-limiting illustrative example, FIG. 6 illustrates a simplified schematic of the operation of a customized agent 116, in accordance with one or more embodiments of the present disclosure. In particular, FIG. 6 depicts a pre-processor 504 that employs both a spatially-aware attention sub-system 602 and a distance-based normalization sub-system 604.

In FIG. 6, the spatially-aware attention sub-system 602 may receive raw observations 508 shown as “Observe Enemy”, “Observe NPC”, “Observe Character Health” and filter out the NPC that is observable in some cases (e.g., defined or at least not excluded by the feature space in step 202), but deemed unnecessary to focus on at this time.

The distance-based normalization sub-system 604 may then normalize data associated with the observations 508 that pass through the spatially-aware attention sub-system 602 and provide this as processed observations 510 to the agent model 502.

The agent model 502 may then generate agent model actions 512 that are normalized and shown here as “Shoot Enemy Normalized” and “Run Towards Enemy Normalized.” The post-processor 506 may then reverse the distance-based normalization provided by the pre-processor 504 to generate final actions 514 suitable for the environment.

Referring again to FIG. 2, in some embodiments, the method 200 includes a step 206 of refining the agent by operating the agent in the environment with human interaction. In step 206, the agent 116 constructed in step 204 may be refined until a specified end condition. Any end condition may be utilized including, but not limited to, a time duration, meeting desired performance thresholds, or discretion of a human user. In some embodiments, the method 200 includes a step 208 of deploying the agent in the environment. For example, the agent 116 may be deployed in pursuit of one or more objectives. Any objectives may be pursued including, but not limited to, debugging, evaluation, or performing one or more tasks within the environment.

In some embodiments, the step 206 is a real-time process in which the agent 116 may be refined based on human feedback at any time. For example, the step 206 may include responding to the human interaction while the agent 116 is operating in the environment. Any selected timeframe may be used such as, but not limited to, less than 30 seconds, less than 10 seconds, less than 1 second, or less than one millisecond. Such an approach enables rapid and efficient refinement of an agent based on human observations and input. The nature of the refinement and the associated human interaction in step 206 may differ based on the type of agent 116 (e.g., the type of agent model 502). Further, the step 206 may be iterated until a selected end condition is met. The end condition may be any suitable condition including, but not limited to, the agent operating according to a performance metric, the agent operating according to the satisfaction of a human user, or after a specified time has elapsed. More broadly, any of the steps of the method 200 may be iterated.

For example, when the agent 116 includes an API coupled with a generative coding mode, the step 206 may include operating the agent 116 in the environment while a human user observes. In some cases, the user has access to the observations passed to the agent 116 for evaluation purposes. The user may then instruct generative code model to update and/or regenerate the executable code based on the performance of the agent 116. As an illustration, when the generative coding model is a LLM, the user may interact with the LLM via prompts, which may be textual or multimodal (e.g., including any combination of text, audio, video, images, or other suitable inputs). This process may be repeated as necessary until the end condition is met.

As another example, when the agent 116 includes a neural network, the step 206 may include training the neural network with training data that may be a combination of human-generated training data and agent-generated training data, where the human-generated training data is associated with operation of the character in the environment by a human user and agent-generated training data is associated with operation of the character in the environment by the agent 116.

Referring now to FIGS. 7-14, systems and methods providing unified agent training utilizing both human-generated and agent-generated training data are described in greater detail, in accordance with one or more embodiments of the present disclosure. The associated descriptions and examples are particularly relevant for, but not limited to, an agent 116 including a neural network.

Agent training generally requires providing an agent 116 with data about the environment they inhabit and how that environment changes in response to actions and/or rewards provided by the environment in response to actions. Training data may generally be provided by humans operating as a character in the environment or by an agent itself operating as the character. In many cases, human-generated training data is higher-quality but relatively expensive to generate, whereas agent-generated training data may be lower-quality but less expensive to generate. Typical systems that combine human-generated data and agent-generated data separate the tasks of creating the human-generated data and the agent-generated data. For example, a typical system may initially create human-generated training data by collecting data as a human operates as a character in the environment and then train an agent on this human-generated training data. Such a system may then collect additional data as this partially-trained agent interacts with the environment and uses this additional data to further train the agent. While this approach is relatively straightforward, it is inefficient and may require vast amounts of agent-generated training data to achieve a desired level of performance.

In some embodiments, the agent deployment system 100 trains an agent 116 in real time and allows switching of a character (e.g., switching the player of the character) between human control (e.g., through I/O devices 110) and agent control (e.g., through the agent client 114) as needed. In this way, the agent deployment system 100 may seamlessly blend human-generated and agent-generated training data to take advantage of the relative benefits of each.

It is contemplated herein that one of the most critical components of realizing a system that can alternate between human-in-the-loop (HIL) and autonomous learning is providing the human training with guidance for when their input is most (and least) valuable. Humans need to know when their input is most valuable so that they can take action when beneficial, but also need to know when they are teaching the agent something it already knows so that they avoid wasting time.

The agent deployment system 100 may utilize various introspective metrics to facilitate efficient switching between human-generated and agent-generated training. One metric that may be used by the agent deployment system 100 is uncertainty, which is a measure of the agent's confidence in its actions during autonomous learning. Another introspective metric is surprise, which measures a difference between an agent's predicted action and the action the human took during a training session (e.g., associated with previously human-generated training data or a simultaneous training session). The metrics of uncertainty and surprise may be combined to facilitate triggers for switching between human and agent training.

For example, an agent may operate in a background state when a human is operating as a character and may generate values of surprise metrics based on a comparison of human actions to suggested actions from the agent based on the same observations. While the value of the surprise metric is above a certain threshold, the agent may continuously train on the human-generated training data. Once the surprise metric falls below the threshold, the agent may be deemed to be sufficiently well trained to operate independently and provide agent-generated training data. In this case, control of the player of the character may switch from the human to the agent.

When the agent is operating as the character, the agent may continually generate values of the uncertainty metric. When the uncertainty metric rises above a threshold, an alert may be provided to take control of the character. This process may then be iterated any number of times in any number of different scenarios. It is contemplated that the use of these introspective metrics may efficiently utilize human effort to generate training data when needed and use agent operation to generate training data when performance human effort is less necessary. This may contribute to a low-latency experience for the human users. Further, this process may minimize unnecessary or counterproductive training data when the agent is not sufficiently trained (e.g., high surprise and/or uncertainty), which may promote robust operation and mitigate hallucinations.

Additionally, in some embodiments, the agent deployment system 100 trains multiple agent models in parallel. These models may then be evaluated by one or more metrics (e.g., uncertainty, surprise, or other metrics) such that the she agent deployment system 100 may actively switch between models to utilize the “best” for a given task.

FIG. 7 illustrates a flow chart of a training process implemented by the agent deployment system 100, in accordance with one or more embodiments of the present disclosure.

A user (e.g., a developer) may customize features of the agent to personalize the training process for a particular environment via the agent client 114. For example, as shown in box 702, a user may set a specification of potential observations and actions for the agent to train on (e.g., define a feature space). As another example, as shown in box 704, the user may instantiate an agent and also define when the character has successfully completed or failed a task. The user defined parameters may be used (e.g., in box 706) to collect the corresponding training data from the environment and send it to the agent server 126. For example, the box 706 may include collecting observations from the environment, sending these to the agent, sending actions from the agent to the environment, and/or collecting rewards from the environment in response to the actions and sending them to the agent. The agent server 126 may receive a signal from the agent client 114 to begin training the agent, and begin implementing one or more training modules 128 directed towards training the agent, evaluating the agent performance, and selecting a model as shown in boxes 708-718. The developer may evaluate the performance of the agent using the selected models to further refine the agent or deploy, as shown in boxes 720-722.

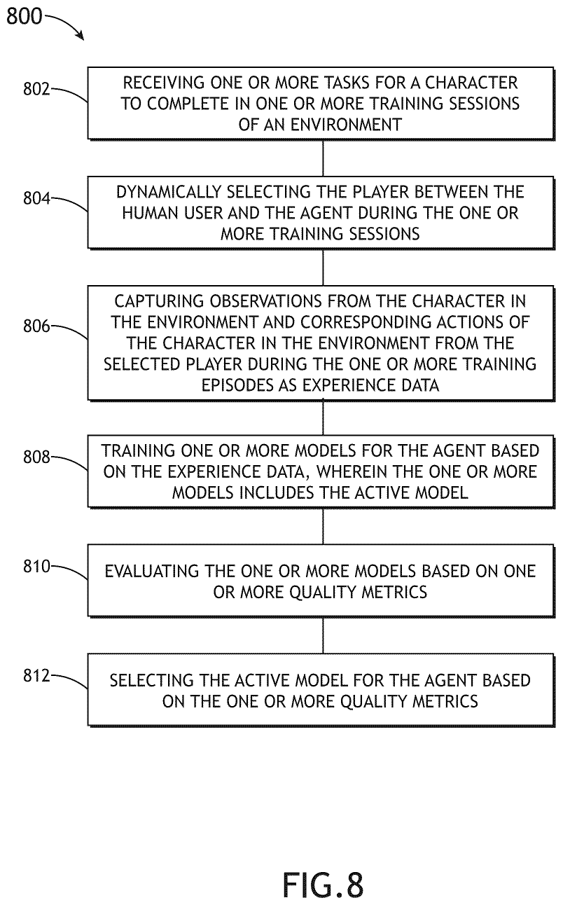

FIG. 8 illustrates flow diagram of a method 800 of training agents (e.g., box 710) to complete tasks in an environment by integrating human and agent training data together.

The method 800 may include a step 802 of receiving one or more tasks for a character to complete in one or more training sessions of an environment. The agent client 114 may be used to indicate to the agent that a training session is starting and training data should be collected. The one or more tasks may include any in-environments objectives that the agent may be trained on. For example, the one or more task may include completing a level, collecting an item, defeating an enemy, reaching a checkpoint, or the like. Once the one or more training sessions has begun, the agent will begin training on the task being attempted. A session may terminate upon any suitable condition including, but not limited to, successful completion of a task, irrecoverable failure to complete a task, or a terminal request by a human user.

The method 800 may include a step 804 of dynamically selecting the character between the human user and the agent during the one or more training sessions. Dynamically switching between human control and agent control may allow a human to provide the agent with high quality human training data when the agent is not able to generate a robust model for the task where. This permits the human to intervene only when needed, requiring less of expensive human training data, while also increasing the quality of the agent training data (thereby requiring less agent training data).

The human character may provide a demonstration of the task, or control the character to complete the task. As the human character controls the character, the agent may use an active model to generate candidate actions based on the observations in the environment collects human generated training data (e.g., the processed observational data and the inputs of the human character), and trains models based on the human generated training data. The agent may provide the human character with a metric corresponding to a trained model, indicating the degree to which the agent believes it can model the human characters demonstration.

The agent may also control the character to complete the task via an active model. As the agent character controls the character, the agent collects agent generated training data (e.g., the processed observational data and the outputs of the agent character), and trains models based on the agent generated training data.

The method 800 may include a step 806 of capturing observations from the character in the environment and corresponding actions of the character in the environment from the selected character during the one or more training episodes as training data. For example, the captured observations may include the observations defined in the feature space (e.g., processed observations). Observations may be captured from either or both the human character or the agent character.

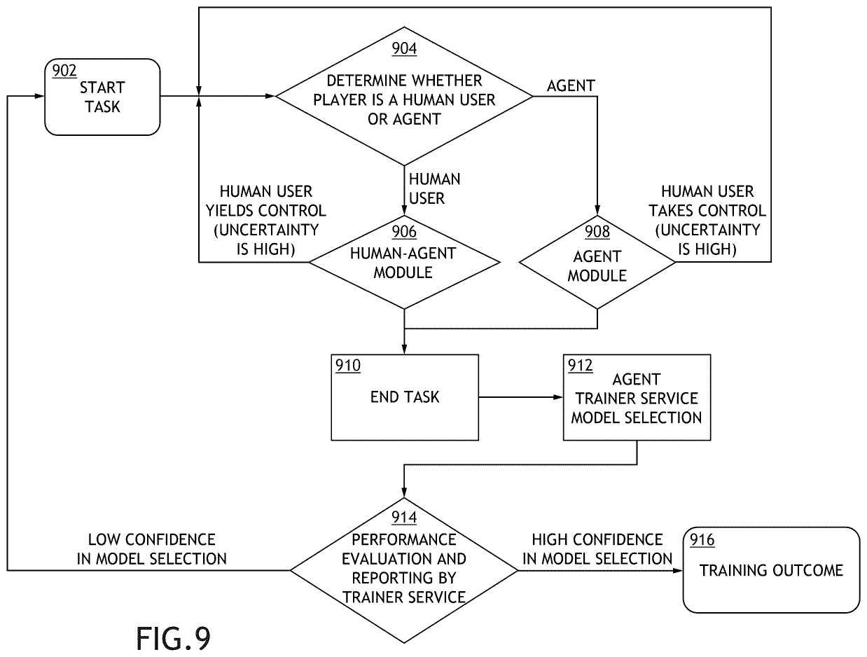

For example, FIG. 9 illustrates a flow diagram of a training process capable of switching between human and agent control of a character (e.g., switching a player of the character), in accordance with one or more embodiments of the present disclosure. Upon the start of a task (e.g., box 902), it may be determined whether the character is human or agent (e.g., 904). For example, if there is no trained agent for the environment, a human character may begin with control of the character in the environment.

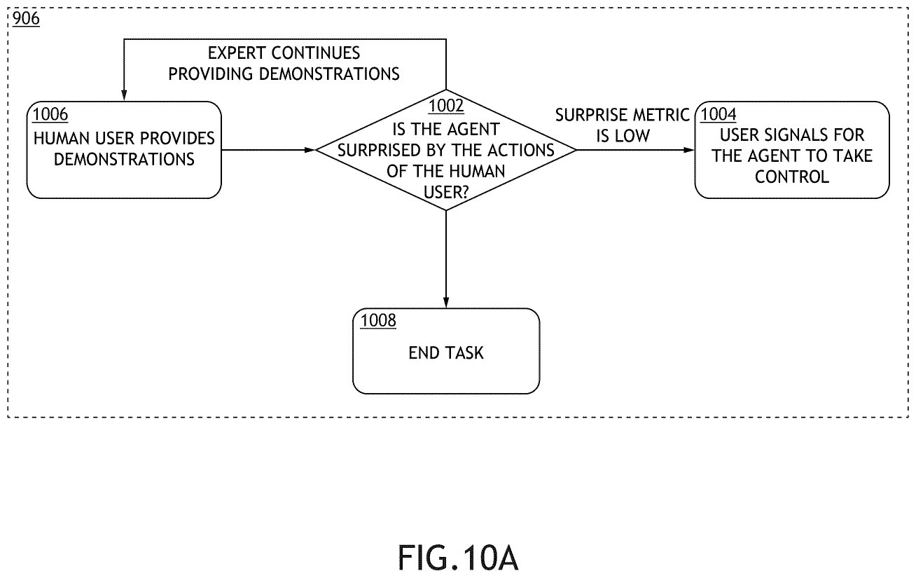

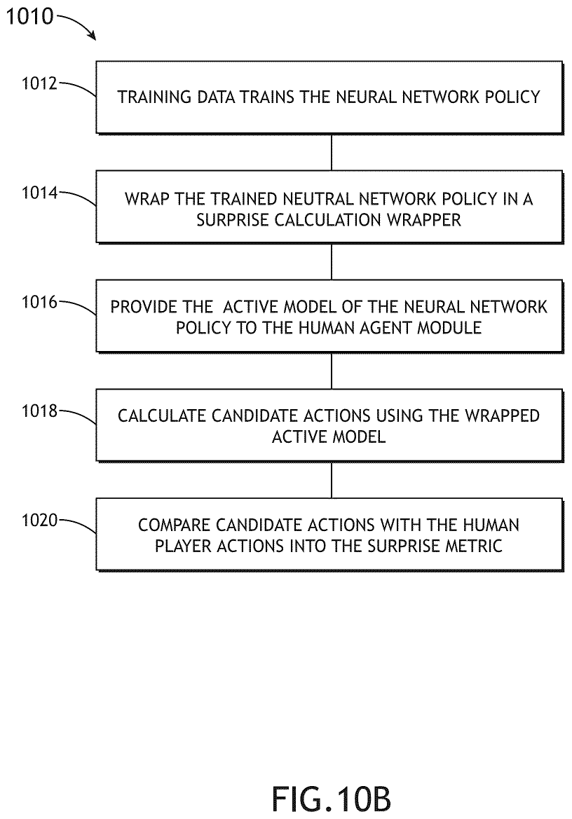

A human-agent module 906 may be implemented to capture training data and compare an active model to the human character actions taken. FIG. 10A-10B illustrate flow diagrams of a process of collecting training data from a human character. For example, the agent may capture the observations from the environment and the inputs that the human character subsequently takes as training data. The agent may process the training data to generate an active model.

The human-agent module 906 may compare the actions predicted by the active model (e.g., the actions or inputs the agent would implement if the agent controlled the character) in a surprise metric. The surprise metric may indicate the degree to which the agent has “learned” the task the human is demonstrating. For example, the surprise metric may indicate how close the active model is to the human character demonstration. For instance, a low surprise metric may indicate that the active model of the agent is calling for similar actions when compared to the demonstration the human character is providing. A higher surprise metric may indicate a large difference in what the active model is predicting when compared to human demonstration. In this instance, additional human character training data may be beneficial to the agent to refine the active model. In this regard, the surprise metric allows a user and/or the system to evaluate whether human character training data is beneficial for the current task, or if the active model is sufficiently trained to on the task to generate agent character training data.

The measure of the surprise metric may be used as a condition for switching between the human character and the agent player of the character. For example, the human-agent module 906 may measure how surprised the agent is by the actions of the human (e.g., box 1002). The surprise metric may be measured by a method 1010. For example, in a step 1012 the training data (e.g., the training data collected from the human character demonstration) may train the neural network policy, which may generate an active model. In a step 1014, the trained active model may be wrapped with a surprise calculation wrapper. The surprise calculation wrapper may act as a function which encapsulates the surprise calculation to the active module. In a step 1016, the active model may be provided to the Human-Agent module 906. In a step 1018, during the human character demonstration, the active model may predict candidate actions that may represent the actions that the model would take if controlling the character. In a step 1020, the candidate actions may be compared to the human character actions, resulting in a measure of surprise.

A surprise threshold may be predetermined by the user (e.g., the developer) to determine a measure of surprise that indicates an acceptable overlap between the candidate actions of the agent and the actions of the human user has been reached by the active model. For example, a value of the surprise measure which is below the surprise threshold may prompt the human character to signal the agent to take control of the character (e.g., box 1004). As another example, a value of the surprise measure above the surprise threshold may indicate that the human-character continues to provide the demonstration. It is herein contemplated that the surprise metric may be evaluated by the system, human character, user, or the like to switch between the human player to the agent.

During the human character demonstration, the character may complete the task, before being switched to the agent (e.g., 1008). For example, the value of the surprise measure may never fall below the surprise threshold before the end of the task.

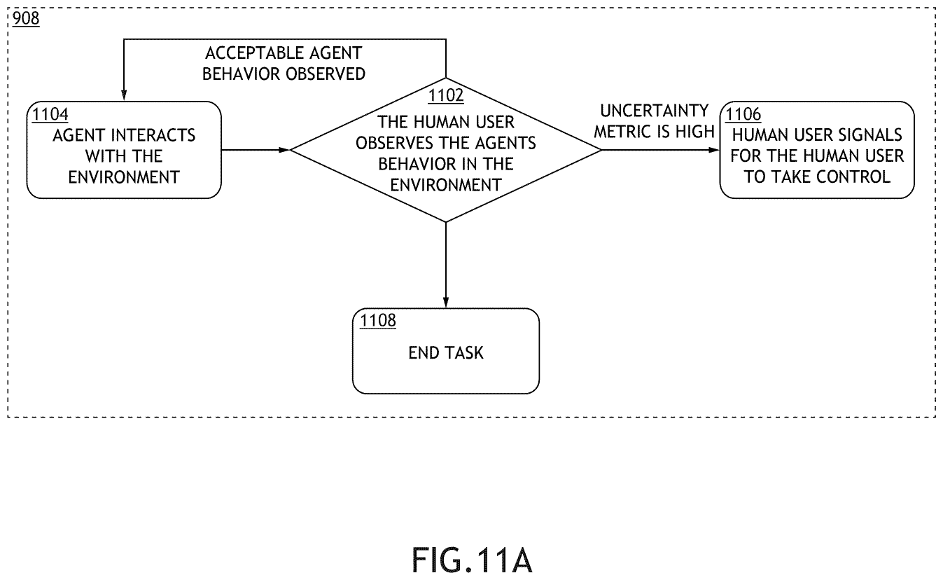

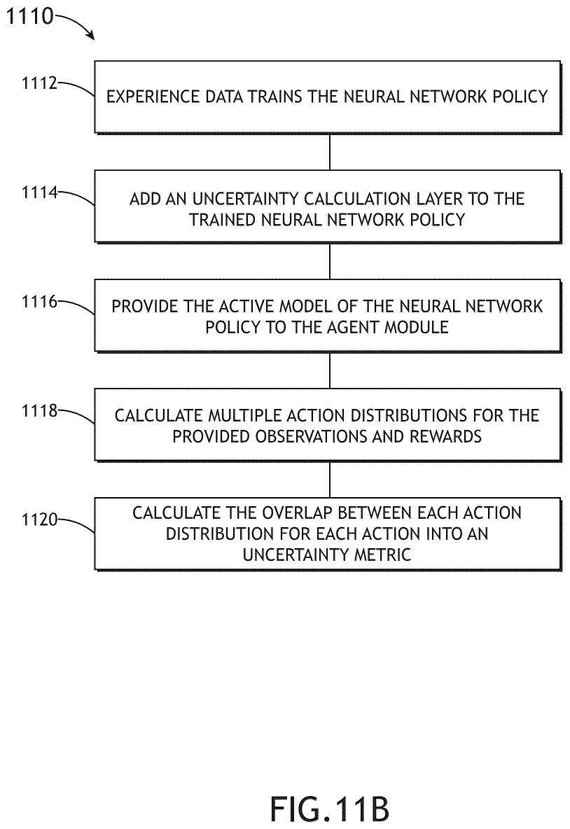

FIG. 11A-11B illustrate flow diagrams of a process of collecting training data from an agent character. An agent module 904 may be implemented when it is determined that a character is an agent. For example, if there is previous training data, the agent may begin the task (box 1104). A human user may then observe the behavior of the agent in the environment (box 1102) for as long as acceptable behavior is observed. However, when an uncertainty metric is high, the human user may take control (box 1106) by any technique. As another example, it may be determined that the character is an agent after switching from the human-character control via the human character module 906 (e.g., the surprise measure is low). The agent may take the actions in the environment as indicated by its active model, with the observations and actions being saved as training data.

The active model is trained according to the available training data, so any deficiencies in the training data may result in the active model struggling to determine the action to take. For example, consider the agent encountering a new observation, such as a new entity. The agent may attempt to address the new entity, but does not have the specific training data to be confident in its actions. This may result the active model indicating multiple and potentially conflicting actions. For instance, the agent may want to run towards the new entity and away from the new entity. Accordingly, the agent module 908 may determine the confidence of the actions of the agent in an uncertainty measure. The uncertainty measure may provide a metric to represent the confidence the agent has in the potential action distributions provided by the active model.

The uncertainty measure may be measured by a method 1110. In a step 1112 the training data collected (e.g., experience data) may train the neural network policy, generating an active model. In a step 1114, the trained active model may have an uncertainty calculation layer added. In a step 1116, the trained active model may be provided to the agent module 908. In a step 1118, multiple action distributions for the provided observations and rewards may be calculated. The multiple action distributions may indicate what actions the agent can take, and an associated likeliness of being chosen distribution. In a step 1120, the overlap between each action distribution for each action may be calculated into an uncertainty measure. For example, high overlap between the action distributions may indicate that the agent would like to take more than more action at a time, or that it is unsure which action is better the take at that time. This would result in a high uncertainty value.

The Agent Module 908 may use the measure of uncertainty to switch the character control from the agent to a human. For example, a predetermined uncertainty threshold may be set to indicate an unacceptable level of confidence in the actions of the agent. A value of the uncertainty measure under the uncertainty threshold may indicate that the agent is confident enough in selecting the actions to continue producing agent generated training data (e.g., box 1104). A value of the uncertainty measure above the uncertainty threshold may indicate that the agent is not confident, and the quality of training data may decrease. In this regard, an uncertainty value above the threshold may indicate for a human character to take control of the character.

The agent module 908 or the human-agent module 906 may end when the character, whether human or agent the task has ended (e.g., box 1108, box 1008, box 910). The training data may be modified to indicate the outcome of the particular task. For example, the training data collected from the task may be configured to include a positive virtual reward if the task was completed successfully. The success of the task may be determined by reward logic defined by a user (e.g., a developer). For another example, the training data may be configured to indicate that the task was failed with no reward associated with the training data.

Referring again to FIG. 8, the method of 800 may include a step 808 of training one or more models for the agent based on the training data. Current model training infrastructure address training as stateless batch processes resulting in training overhead that is much larger that the setup overhead, resulting in higher latency model training. In traditional machine learning systems, this design is optimized to process enormous amounts of data even if it takes the systems days or weeks to do so. However, this high latency infrastructure would result in a longer time between a human taking an action, and seeing the result in the active model, making the dynamitic switch between a human player and agent player ineffective. Rather, a low latency model training infrastructure is desirable.

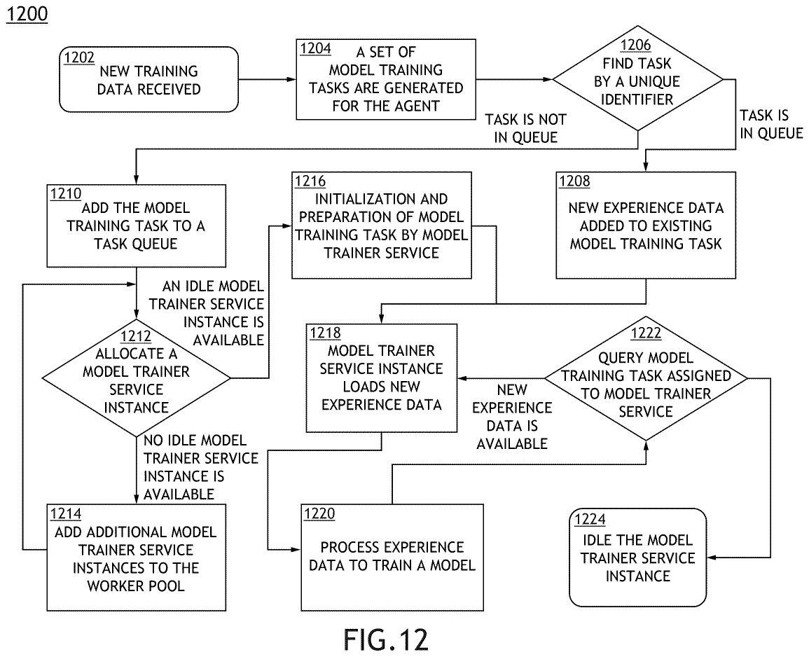

FIG. 12 illustrates flow diagram of a trainer service 1200, in accordance with one or more embodiments of the present disclosure. Trainer service model selection, performance evaluation, and training outcomes are also depicted in Boxes 912-916 of FIG. 9. The trainer service may generate and train the models for the agent, while utilizing locality to allocate a trainer instance, and try to keep it persistent while training is active. Using the trainer instances may reduce the overhead due setting up many different trainers when the data set size is relatively small. Rather, the trainer service may iteratively train models, resulting in low latency model training. The trainer service may also schedule training based upon the selection of hardware available to receive the fastest result, resulting in efficient, low latency training.

The training data, including observations, actions and rewards, may be sent and received by the trainer service 1200, as shown in box 1202. The training data may be received from received from the human-agent module 906 and/or agent module 908.

A set of model training tasks may be generated for the agent box (e.g., in box 1204). The model training tasks may reference the received training data to be trained with, the agent schema (e.g., actions and/or observations), and hyperparameters. The hyperparameters may configure the policy while training, with regards to the learning process while not determining the model itself. For example, hyperparameters may include the learning rate or choice of optimizers. Hyperparameters may be defined before training commences. The agent schema and hyperparameters may be used as a unique identifier for each model training task.

The trainer service 1200 may use the unique identifier for each model training task to determine if the model training task is already in a training queue, as shown in box 1206. If the model training task is in queue, new experience data may be added to the existing model training task (box 1208). If the model training task is not in queue, the model training task will be added to the task queue (e.g., box 1210), and allocated a model trainer service instance, as shown in box 1212. If there are no idle model trainer service instances available, additional instances may be created as shown in box 1214. Once there is an idle model trainer service instance available, the idle model training service instance may be notified of the new model training task, and initialize and prepare for training, as shown in box 1216. For example, the model training service instance may compile policy components required for training the policy given the experience data and the agent schema and load all historical experience data required to train the agent.

The model trainer service instance may load the new training data as shown in box 1218, and process the training data to train a model as shown in box 1220. The training data may be processed in a variety of manners. For example, the trainer service 1200 may use trajectory amplification to process the training data. Otherwise, the model training service may be idled (box 1224).

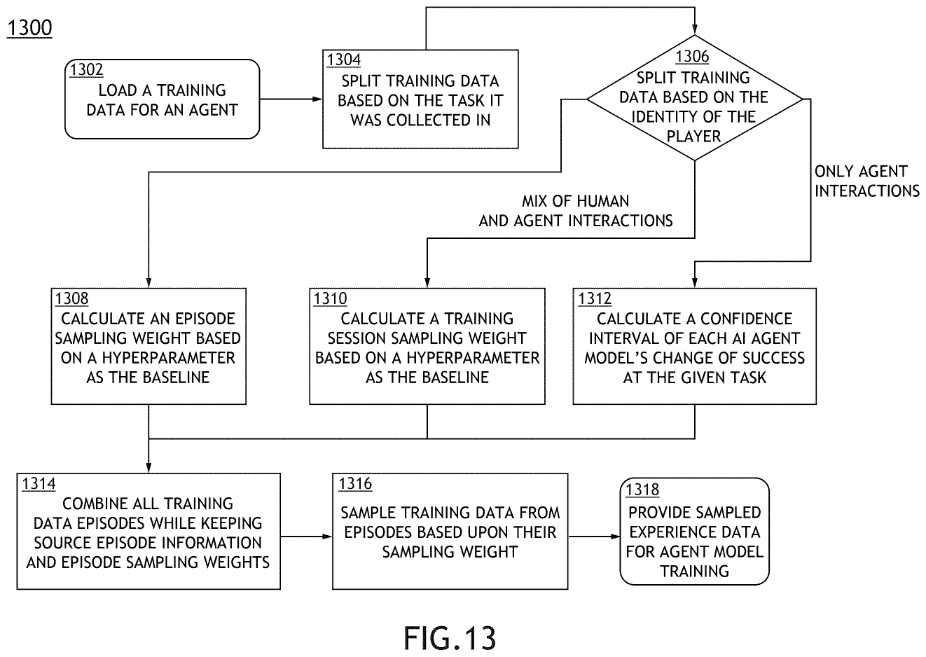

FIG. 13 illustrates the process of trajectory amplification 1300. Trajectory amplification may allow the training service to weigh training data collected from different training sessions (e.g., human character, agent character, or a hybrid of human and agent) differently. By weighing the training data, the training service may be able to sample the training data associated with more successful models at a higher frequency, resulting in higher quality training.

In a step 1302, all the training data for an agent is loaded. In a step 1304, the training data is split based upon the task the data was collected from. In a step 1306, the training data associated with each task is split based upon the character. For example, the training data may split between demonstrations from human characters only, demonstrations from a mix of human and agent interactions, or agent only interactions.

Training data from demonstrations of only human characters may be classified as full demonstration training sessions. In a step 1308, the full demonstration training sessions may be weighed according to a task sampling weight. The task sampling weight may be calculated based on a hyperparameter, such as learning rate, or optimizer. The task sampling weight may also reflect the age to the training data.

Training data from demonstrations of a mix of human characters and agent interactions may be classified as correction training sessions. The agent actions from the training data may be removed from the correction training sessions. In a step 1310, the correction training sessions may be weighed according to a task sampling weight. The task sampling weight may be calculated based on a hyperparameter, such as learning rate, or optimizer. The task sampling weight may also reflect the age of the training data.

Training data from the agent interactions may be classified as autonomous episodes. In a step 1312, a confidence interval may be calculated the reflect the probability of success at the task for each agent model. A multi-armed bandit algorithm may be used to calculate the confidence interval. Using the lower confidence bound of the probability of success of each model may be used to calculate a task sampling weight. The autonomous episode may be weighed by the task sampling weight. If the training data indicates that the task was failed, the autonomous episode may receive a weight of zero.

In a step 1314, all the training data episodes (e.g., full demonstration episodes, correction episodes, and autonomous episodes) with their corresponding task sampling weights are combined into a data set. In a step 1316, the training data is sampled according to the weights given to the respective episode. For example, a larger weight associated to an episode may correspond to a higher probability of the episode training data being sampled. As another example, training data from an episode with a weight of zero will never be sampled. In a step 1318, the sampled experience data is provided to the respective model training service instance for model training.

The model trainer service instance trains a policy from the processed (e.g., sampled) training data. The policy may be trained with dropout enabled to prevent overfitting and facilitate the uncertainty calculation. A model of the policy may be configured to include a surprise wrapper and/or an uncertainty calculation layer and exported to the human-agent module 906 and/or the agent module 908.

The trainer service may query the model training task assigned to the model trainer service instance for new training data, or check if any addition new experience is available for the model training task, as shown in box 1222. If additional training data is available, the new experience data will be loaded by the instance and boxes 1218-122 will iterate until no new training data is available. By reusing the model trainer service instance for the same model task training, the overall overhead required is decreased, as all the training data has already been loaded and the instance already initialized.

When no new training data is available, the model trainer service may idle, permitting the instance to be allocated to a different model training task.

Referring again to FIG. 8, the method 800 may include a step 810 of evaluating the one or more models based on one or more quality metrics. The one or more quality metrics may include a variety of indicators of the quality of the model. For example, the models may be evaluated by a confidence interval and estimated quality calculated to reflect the probability of success at the task for each model as a quality metric. A multi-armed bandit algorithm may be used to calculate the confidence interval.

Referring again to FIG. 8, the method 800 may include a step 812 of selecting the active model for the agent based on the one or more quality metrics.

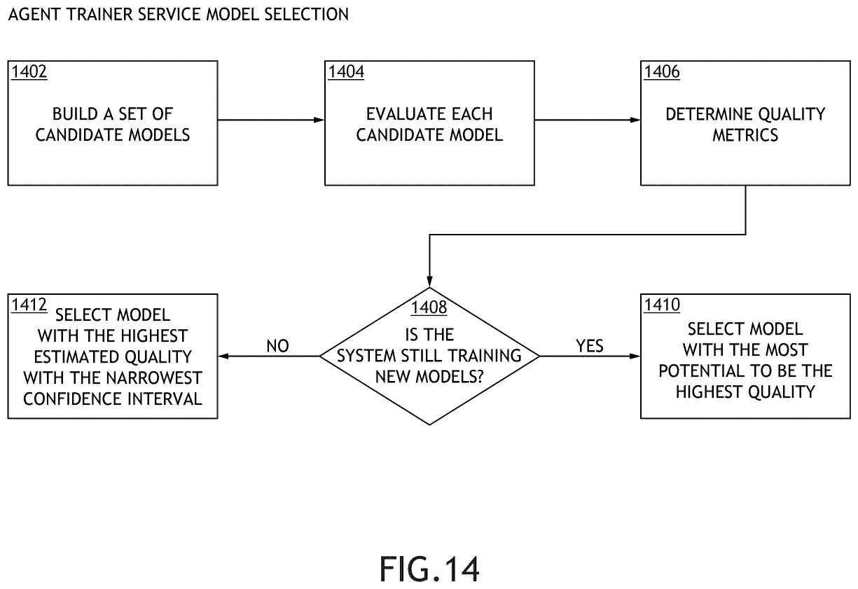

FIG. 14 illustrates a flow diagram for selecting the active model for an agent. A set of candidate models may be built as defined by a user, as illustrated in Box 1402. For example, a user may direct the set of candidate models to reflect the models which were training on the most recent received training data.

Each model from the set of candidate models may be further evaluated, as illustrated in box 1404. For example, for each model, it may be calculated how many times the model has been used to complete a task in the environment, how many times the model has failed or succeeded the task, or the like.

Each model from the set of candidate models may have quality metrics determined for them, as illustrated in box 1406. For example, each model may have an estimated quality and probability interval determined. The system may then determine whether the system is still training new models (e.g., box 1408). If the system is still training new models, the model with the most potential to be the highest quality will be selected as the active model for the agent (e.g., box 1410). For example, the model with the highest estimated quality upper confidence bound may be selected as the active model. The agent may begin using the active model in the agent module and agent-human module to iteratively train. If the system is no longer training new models (e.g., no more training data is accumulating), the model with the highest estimated quality with the narrowest confidence interval may be selected as the active model (e.g., box 1412). This active model may be evaluated for its efficiency to decide if additional training or refinement is required.

Referring now to FIGS. 15-18, systems and methods for synchronizing and displaying multiple data streams associated with one or more characters 302 within an environment are described in greater detail, in accordance with one or more embodiments of the present disclosure.

In some embodiments, the agent deployment system 100 provides an interactive interface that allows a user to actions of one or more characters 302 as they interact with the environment and review data such as, but not limited to, telemetry data, observations of the character 302, actions of the character 302, or a video stream in the environment. Such an interface may be useful for, but is not limited to, understanding the behavior of a character (e.g., a human character, an agent character, or an application in which a character is alternately controlled by a human and an agent). However, these various datasets may be generated using different processes and/or at different framerates. As a result, these various datasets may not be fully synchronized and may further have gaps at different times, which may complicate analysis.

FIG. 15 illustrates a flow chart for a method 1500 for synchronizing and displaying multiple data streams into a unified time stream associated with one or more characters 302 within the environment, in accordance with one or more embodiments of the present disclosure.

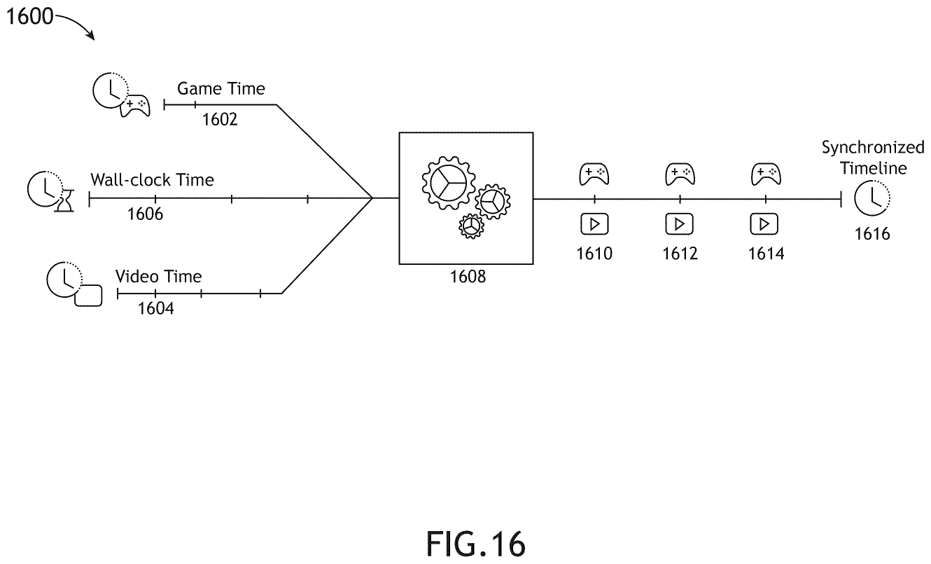

FIG. 16 illustrates a simplified schematic 1600 of synchronizing multiple data streams into a unified time stream 1616 (e.g., a synchronized timeline), in accordance with one or more embodiments of the present disclosure.

In some embodiments, the method 1500 may include a step 1502 of capturing telemetry data of one or more characters 302 within an environment, where the characters may be human characters, agent characters, or a combination thereof (e.g., a character that has been alternately controlled by a human and an agent).

The telemetry data may include, but is not limited to, environment data such as, for example, character's position (e.g., move feelers), character's movements (e.g., rotation, state), character's actions, and the like. As such, it is contemplated herein that the telemetry data for each of the characters 302 may include a time stream of inputs (e.g., observations) provided to the corresponding characters 302 and outputs (e.g., actions) taken by the characters 302. In FIG. 16, a time stream associated with a gameplay episode may include telemetry data captured in environment time 1602. As a non-limiting example, the environment time 1602 may be time as viewed from a game engine.

In some embodiments, the method 1500 may further include a step 1504 of capturing video data of the one or more characters 302 within the environment simultaneously with the telemetry data.

The video data may include, but is not limited to, video data associated with a state of the environment such as, for example, rendered pixels in a videogame. The video data may further include audio or other information associated with the environment as the character interacts with the environment. In FIG. 16, a time stream associated with a gameplay episode in video time 1604 associated with the video data. As a non-limiting example, the video time 1604 may include a time viewed from a video of the gameplay episode.

In some embodiments, the method 1500 may further include a step 1506 of embedding metadata into the telemetry data and/or the video data associated with a state of the environment. The metadata may include, but is not limited to, any information that may be provided within the environment such as, for example, time stamps, character information, and the like.

The metadata may be associated with the feature space. For example, as noted previously herein, the feature space selected by the user may include the subset of the total set of observations and/or the total set of actions available to the character in the environment.

In some embodiments, the method 1500 may further include a step 1508 of synchronizing the telemetry data and the video data into a unified time stream 1616 (e.g., a synchronized timeline) based at least in part on the metadata.

The synchronization algorithm 1608 may embed metadata and correlate time-series metadata, such as environment time 1602 (e.g., game time), video time 1604, and wall-clock time 1606, into the unified time stream 1616. For example, in FIG. 16, the environment time 1602 is captured in the stream of telemetry data (e.g., a telemetry stream). By further way of example, in FIG. 16, the video time 1604 is captured in the stream of video data (e.g., a video stream).

The telemetry stream and the video stream are independently generated and can be recorded at different framerates, have different resolutions, have gaps in time, etc. As such, correlating the video data with the telemetry data incorporates familiar imagery with the underlying data associated with the state of the characters 302. In this regard, the synchronization algorithm 1608 tracks the state of the entire agent deployment system 100 and correlates the time-series metadata into the unified time stream 1616. For example, in FIG. 16, the synchronization algorithm 1608 correlates the disparate time streams (i.e., the environment time 1602, the video time 1604, and the wall-clock time 1606) by synchronizing each frame of data captured with a specific bit of telemetry data and vice versa. In this instance, the wall-cock time 1606 may be used as an absolute, external reference to synchronize the environment time 1602 and the video time 1604 which was likely stretched or compressed compared to the wall-cock time 1606.

Synchronized environment time 1610, synchronized video time 1612, and synchronized wall-clock time 1614 are correlated into a unified time stream 1616 showing the synchronized telemetry data and video data of the characters 302 for the three different times. Thus, the user may revisit the gameplay episode through a display device providing the user a wider perception on the characters 302 behavior at any moment in time.

In some embodiments, the method 1500 may further include a step 1510 of displaying the unified time stream 1616 to the user.

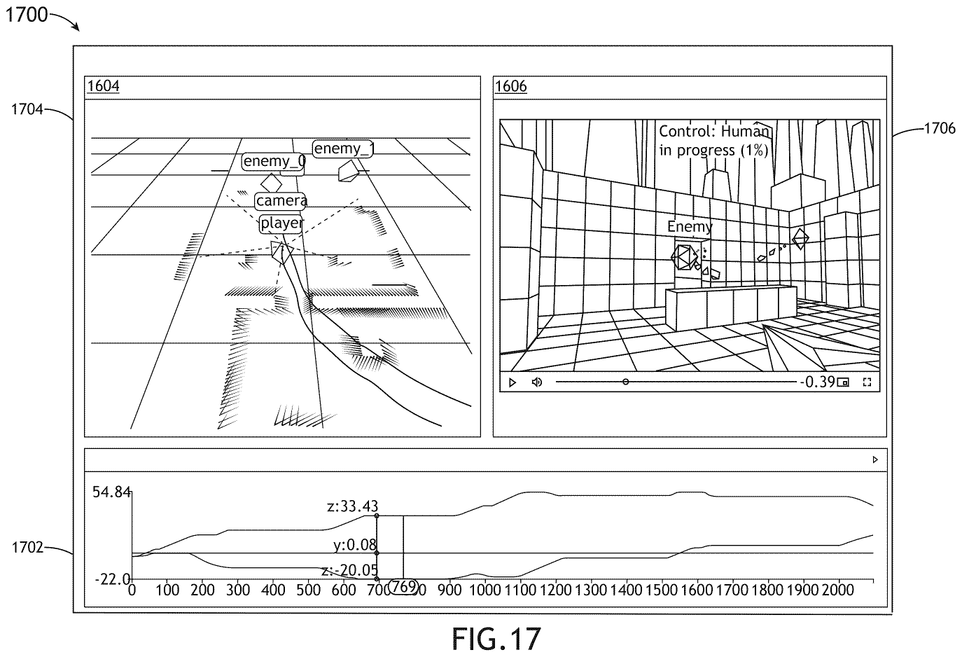

FIG. 17 illustrates a simplified schematic displaying the unified time stream 1616 through an interactive interface 1700 on a display device (e.g., display 112 or another display device), in accordance with one or more embodiments of the present disclosure. For example, the step 1510 may include displaying the unified time stream 1616 through the interactive interface 1700. In this regard, the interactive interface 1700 may provide a graphical user interface with one or more panels. The one or more panels may include a timeline view of the unified time stream, a spatial view of the unified time stream, and/or a video view of the unified time stream.

The interactive interface 1700 may provide, but is not limited to, the spatial representation of the telemetry data. For example, the spatial representation of the telemetry data may illustrate the inputs (e.g., observations) provided to the characters 302 as well as the outputs (e.g., actions) taken by the characters 302. The spatial representation of the telemetry data may be presented in both 2D and 3D while synchronizing with video data captured from the environment.

For example, in FIG. 17, panel 1702 illustrates a 2D view of telemetry data, panel 1704 illustrates a 3D view of telemetry data, and panel 1706 illustrates video data.

In particular, the panel 1702 may provide a timeline view of the unified time stream 1616. In this regard, the panel 1702 may illustrate a unified time stream 1616 after correlating time-series metadata through the synchronization algorithm. The timeline view of the unified time stream 1616 may be displayed showing time on the x-axis and UNITS on the y-axis.

The panel 1704 may provide a spatial view of the spatial representation of the telemetry data. In this regard, the panel 1704 may display an interactive 3D view of the telemetry stream. The observations and the actions taken by the character 302 may be viewed from different perspectives at different points in time.

Where the one or more characters 302 includes two or more characters 302, the interactive interface 1700 may provide telemetry data associated with a single one of the one or more characters 302. For example, multiple runs of a single one of the one or more characters 302 on the same task may be displayed. Further, where there are two or more characters 302 within the environment, the interactive interface 1700 may provide one or more composite views of data associated with at least two of the two or more characters 302. For example, multiple runs of the one or more characters 302 on the same task may be displayed.

The panel 1706 may provide a video view of the unified time stream 1616. For example, a video view of the video data may illustrate a video playback of the screen displayed to the character 302 during the gameplay episode.

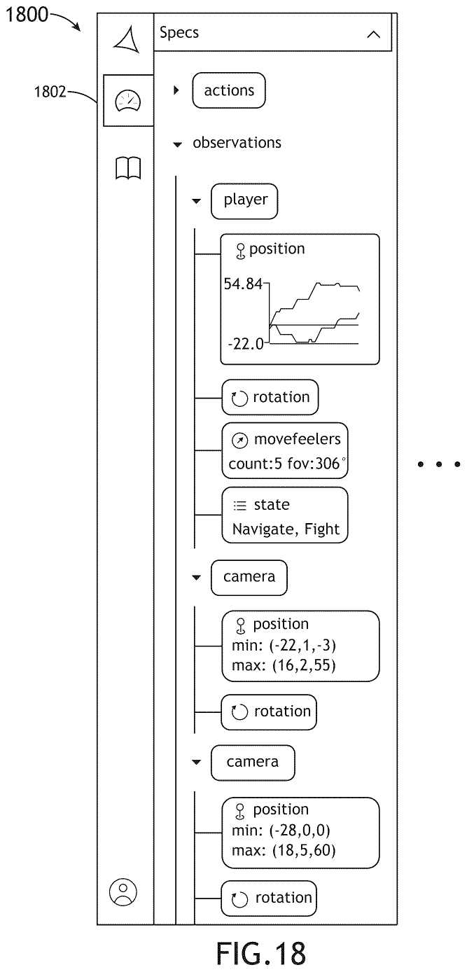

FIG. 18 illustrates an interactive interface allowing a user to control visualization of desired portions of the unified time steam, in accordance with one or more embodiments of the present disclosure. simplified schematic providing a user with a telemetry stream synchronized to the telemetry data through an interactive interface 1800 on a display device, in accordance with one or more embodiments of the present disclosure.

In some embodiments, the interactive interface 1800 may provide a graphical user interface with one or more configuration panels 1802 that allow a user to select at least one of a portion of the unified time stream for visualization or a visualization axis, where the visualization axis may be space, time, or any other suitable visualization axis in the environment. Further, the user may select any portion of the unified time stream associated with any telemetry data including, but not limited to, actions made by any character, observations available to any character, observations actually received by an agent when playing a character, or the like. Further, in some embodiments, the observations may include attributes associated with any character such as, but not limited to, health, status, or inventory.

In this regard, in FIG. 18, the one or more configuration panels 1802 may display various data associated with the feature space and/or the state of the environment such that the user may tailor visualizations provided in other panels (e.g., as depicted in FIG. 17, or the like). As a non-limiting example, the interactive interface 1800 may allow the user to review data associated with one or more characters 302 as they interact with the environment such as, but not limited to, telemetry data, observations of the character 302, actions of the character 302, or a video stream in the environment.

It is contemplated herein that the interactive interface 1800 may allow a user to observe a variety of information associated with characters in the environment and gain insights based on the selection of visualized elements. For example, when observing a unified time stream associated with an agent that is not performing according to desired specifications (e.g., failing to perform a task), the interactive interface 1800 may allow a user to visualize key data in space and/or time that may assist the user in refining the agent (e.g., as described with respect to the method 200). As an illustration, a user may visualize, via the interactive interface 1800, observations of the agent in the environment (e.g., whether the agent is accurately identifying enemies or objects in the environment) as a function of space and/or time. It is to be understood that these examples are provided solely for illustrative purposes and should not be interpreted as limiting the spirit and scope of the present disclosure. A user may gain any type of insight based on any combination of visualized data provided by the interactive interface 1800.

Referring now to FIG. 19-29, systems and methods for generating versioned snapshots, execution telemetry and optimization of a generative computational module (e.g., generative software, generative software components, or the like) are described, in accordance with one or more embodiments of the present disclosure.

It is contemplated herein that the systems and methods depicted in FIGS. 19-29 may be utilized by the agent deployment system 100 for a customized agent 116 as disclosed herein. For example, these systems and methods may be used for versioning of a neural network associated with an agent 116, a generative coding model associated with an agent 116, or any other generative software component (or generative computational module). However, the systems and methods depicted in FIGS. 19-29 are not limited to applications incorporating an agent 116 and may be broadly applicable to any generative computational module known in the art such as, but not limited to, large language model chatbots or generative text-to-image systems. In this way, the examples related to the agent deployment system 100 or the customized agent 116 are provided solely for illustrative purposes and should not be interpreted as limiting the scope of the present disclosure.

Generative software is difficult to build, maintain, and optimize using traditional software engineering systems and methodologies. Previous systems relied on traditional control systems such as Git or SVN for code versioning and simple logging mechanisms for telemetry. These limitations rendered these systems unable to support the capture of fine-grained execution data and generate insights for optimization. For example, tasks like debugging and performance profiling are traditionally performed manually and are time-consuming in nature, creating challenges in identifying bottlenecks in complex generative software.

Embodiments of the present disclosure provide a comprehensive approach to addressing challenges involved in generative software development by integrating versioned memory, high-precision execution telemetry, and optimization processes of generative software applications. This includes a structured programming framework for versioned storage of code and code executions. The versioned memory system allows the ability to efficiently search for past executions of the generative software that executed a given software component, received a given input, produced a given output, or raised a given exception.

The system further provides the ability to automatically instrument code to allow granular resampling of the generative software system, perform asynchronous and distributed executions of programs, and enable searching executions of the input software to optimize them. The optimization system implemented can be applied to human workflow, generative software, or a combination of the two. Optimization techniques can be gradient-based, gradient-free, or a combination of the two.

The present disclosure streamlines the development, maintenance, and optimization of generative software, including higher-order generative software, through versioned memory, precise execution telemetry, and efficient optimization capabilities.

FIG. 19A illustrates the method 1900 of executing versioned snapshots, execution telemetry and optimization of the customized agent 116. In some embodiments, method 1900 may include the step 1902 of executing a generative neural network to provide an output dataset in response to an input dataset. As described previously herein, the generative neural network may consist of, but is not limited to, the customized agent 116 such that references to the customized agent 116 herein are merely exemplary.

In some embodiments, the method 1900 may include the step 1904 of committing versioned resources to a memory medium to generate snapshots of the resources on the memory medium, with some of the versioned resources including particular instances of code, input data sets, and output datasets. As used herein, the term resource refers to an item to be versioned, and a snapshot refers to a particular stored instance of a resource. These committed resources may then be searchable. In this way, the resources may be identified and/or categorized and then checked out for execution or re-execution.

The method 1900 may be used to generate versioned storage for a wide variety of resources. In some instances, the one or more resources may include particular instances of code from the customized agent 116, the input datasets provided to the particular instances of code, and the output data sets generated by executing the particular instances of code using the particular input datasets. The one or more resources may also include generative or nongenerative components.

For example, resources may include code and parameters for selected generative and non-generative components. This can also include nested software components, where the nested software components may be associated with modules, routines, or sub-routines of a larger codebase. The one or more resources can have unique identifiers based on a hash digest, which is a deterministic function of the resource's content and type. The hash digest is an output of a hash function, which maps inputs of varying sizes to a fixed length.

As another example, the one or more resources may include one or more programming exceptions encountered during previous executions and journaled execution traces. The exceptions are events that occur during the execution of the customized agent 116 that may disrupt the operation of the customized agent 116.

In order to archive the inputs, outputs, and exceptions generated during executions, the system may also provide one or more journaled execution traces. The journaled execution traces relate executed software components with the input datasets, the output datasets, and the one or more programming exceptions produced during the execution. Each of the one or more journaled execution traces are further associated with journaled execution traces of subcomponents executed and snapshots of the executed software components before and after the execution.

Further examples of components of journaled executions may include snapshots of generative computational modules before and after execution, snapshots of inputs to the generative computational module, snapshots of outputs of the generative computational module, snapshots of exceptions produced during the execution, and a list of ordered snapshots of the journaled executions performed to determine a specific output. Journaled executions of the generative software require the user to annotate relevant software components. The relevant software components may then be automatically instrumented to support journaling executions and ability to process past journaled executions.

A snapshot is an instance of a generative computational module. For example, content included in the snapshot could be input data, output data, or telemetry data. The method may be implemented using an automatic code instrumentation. For example, when the user implements the customized agent 116, calls to customized agent 116 or associated components may be intercepted. The automatic code instrumentation may also allow the returning of outputs from previous executions rather than having the customized agent 116 re-execute tasks.

In some embodiments, the method 1900 may include the step 1906 of checking out one or more of the snapshots of any of the resources when prompted. Checking out of the one or more snapshots may produce an equivalent copy of the resource to use as a reference. The one or more snapshots may be checked out by one or more generative optimization algorithms. The one or more generative optimization algorithms may then make changes to components of the customized agent 116. The generative optimization algorithms may be located on one or more servers 118 through one or more computer networks.

With respect to committing resources to the memory medium, the snapshots serve as models, consisting of a series of nodes and weights that are stored in the memory medium. The data the snapshots capture includes the inputs and outputs of the generative neural network and serves to keep record of relevant information from prior executions, which is then checked out when the system is prompted.

The data captured by the one or more snapshots may also include detailed execution telemetry data. This may include a record of inputs, outputs, and calls to subcomponents of the customized agent 116. The one or more snapshots may be kept on the memory medium of the agent client 114 or across one or more servers 118 through one or more computer networks. Through this storage system, the one or more snapshots can further comprise a versioning module. In this versioning module, iterations of generative neural network (e.g., customized agent 116) components, and corresponding inputs, outputs, and exceptions may be recorded. The one or more snapshots may be immutable records of one or more resources of the executions of the customized agent 116. For example, these one or more resources may contain information on design and execution of the customized agent 116 or associated components.

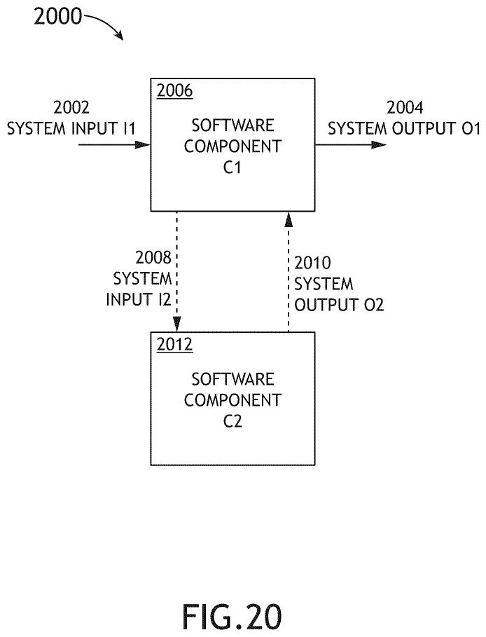

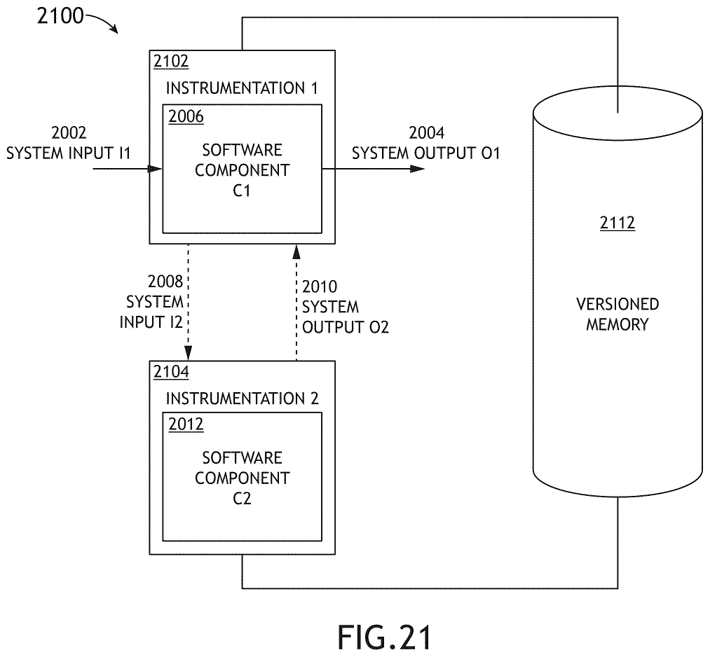

Referring now to FIGS. 20-21, the process for taking a snapshot and checking it out using versioned storage is explained in greater detail. FIG. 20 is a closed diagram showing the physical embodiment of step 1902 and step 1904, where step 1902 is the execution of the generative neural network (AI agent), and 1904 is the generation of the snapshots.

FIG. 20 illustrates an example schematic 2000 of how an execution occurs, in accordance with one or more embodiments of the present disclosure. The schematic 2000 may include a first input 2002 (I1) into a first software component 2006 (C1). The schematic 2000 may also include a first output 2004 (O1). The schematic 2000 may also include a second input 2008 (I2) into a second software component 2012 (C2), which may be referred to as a nested component. The second input 2008 (I2) may contain datasets influenced by the execution in the first software component 2006 (C1). The schematic 2000 may also include a second output 2010 (O2) from the second software component 2012 (C2).

FIG. 21 illustrates an example schematic 2100 of how an execution is snapshotted and stored, in accordance with one or more embodiments of the present disclosure. The schematic 2100 may also contain a first automatic code instrumentation 2102, which may include processors configured to execute program instructions to implement the software component 2006 (C1) stored on a memory. The first automatic code instrumentation 2102 may be programmed to automatically track all inputs and outputs correlated with the first software component 2006 (C1). The first automatic code instrumentation may then relay a record of the first input 2002 (I1), the first output 2004 (O1), and calling the first software component 2006 (C1) to the versioned memory 2112. The schematic 2100 may also contain a second automatic code instrumentation 2104, which may include processors configured to execute program instructions to implement the software component 2012 (C2) stored on a memory. The second automatic code instrumentation 2104 may be programmed to automatically track all inputs and outputs correlated with the second software component 2012 (C2). The second automatic code instrumentation may then relay a record of the second input 2008 (I2), the second output 2010 (O2), and calling the second software component 2012 (C2) to the versioned memory 2112.

The one or more resources can be committed to a store, located on the versioned memory 2112. The store may contain one or more snapshots that represent the one or more resources content and state of the system in an instance of execution.

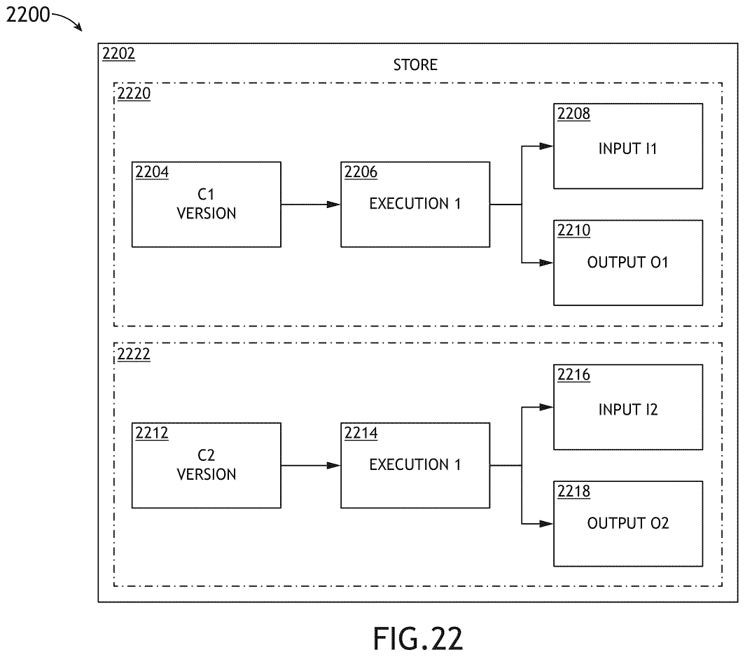

FIG. 22 illustrates a schematic 2200 providing execution of any version of the previously documented executions by accessing a store 2202 and checking out the snapshots (e.g., in accordance with step 1906), in accordance with one or more embodiments of the present disclosure. FIG. 22 illustrates an example of multiple resource sets 2220, 2222, as part of the store 2202. A resource set 2220 may contain C1 version 2204, a journaled execution trace 2206, an input I1 2208, and an output O1 2210. For example, the C1 version 2204 may contain code and parameters associated with one version of the customized agent 116. The journaled execution trace 2206 relates the input I1 2208 and the output O1 2210 with C1 version 2204. Similarly, a resource set 2222, contains an C2 version 2212, a journaled execution trace 2214, an input I2 2216, and an output O2 2218. The C2 version 2212 may then contain code and parameters associated with a second version of the customized agent 116. The journaled execution trace 2214 relates the input 2216 and the output 2218 with C2 version 2212.

Furthermore, the store 2202 may be used to house one or more compound resources. The store 2202 may track the one or more compound resources in a graph structure. For example, a journaled execution trace may reference a snapshot of its corresponding input and output datasets. This may result in multiple journaled execution traces sharing the same input and the same snapshot in the store. The user may choose constraints upon what components are tracked in the store.

The store 2202 is capable of being searched for a specific snapshot within the search graph. Each specific snapshot is associated with a unique hash digest, allowing for efficient searching. If the user is given a specific resource, the user can then search for a set of resources that refer to the specific resource. The user may accomplish this task by creating a snapshot and querying the store for the set of resources that reference the snapshot. Advantages to using this feature include the ability to curate datasets for training by retrieving all previous executions of a specific software component, regardless of when or how it was executed.

In some embodiments, generative software (e.g., the customized agent 116 or any other type of generative code) may be ordered to perform higher-order generation, where the generative software creates or modifies other software systems. More specifically, the generative software may be ordered to iterate or alter the code and data of other software systems to correlate performance of the generative software with a configuration of the generative computational modules.

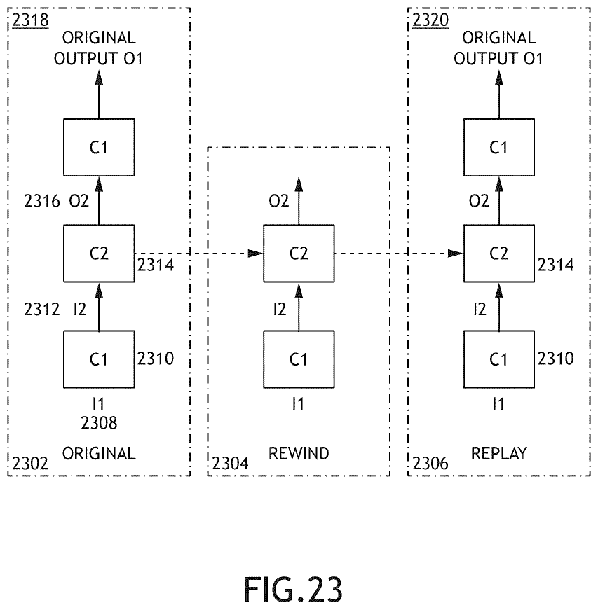

FIGS. 23-25 demonstrate the various non-limiting ways the snapshots may be utilized once checked out of the store. For example, FIG. 23 illustrates that snapshots of an original execution 2302 may be checked out to perform a rewind 2304 or a replay 2306. In this figure, the snapshot of the original execution 2302 may include a first input 2308 (I1) into a first software component 2310 (C1). The snapshot of the original execution 2302 may also include a second input 2312 (I2) into a second software component 2314 (C2). The second input 2312 (I2) may contain datasets influenced by the execution in the first software component 2310 (C1). The snapshot of the original execution 2302 may also include a second output 2316 (O2) from the second software component 2314 (C2). The snapshot of the original execution 2302 may also include output 2318 (O1) produced from the second output 2316 (O2) being applied to the second software component 2314 (C2).

The rewind 2304 may allow the system to revert to specific instances in the original execution 2302. For example, the rewind 2304 may include the first input 2308 (I1), the first software component 2310 (C1), the second input 2312 (I2), the second software component 2314 (C2), and the second output 2316 (O2), but omit the first output 2318 (O1) generated by the first software component 2310 (C1).

The replay 2306 is a journaled re-execution of the system in which some selected components are re-executed, while other components return outputs referenced in the original execution 2302. During replays, code instrumentation inserted by the system intercepts the calls to the customized agent 116 or other generative components and returns previously stored results in the original execution 2302. The original execution is restored to the original state after the replay 2306.

For example, replay 2306 may contain all selected components and outputs present in rewind 2304. In addition, replay 2306 may re-execute the first software component 2310 (C1) with the second output 2316 (O2) to generate a new version of the output O1 2320.

The ability to rewind and replay executions makes it possible to systematically search the tree of possible executions using the graph search capabilities.

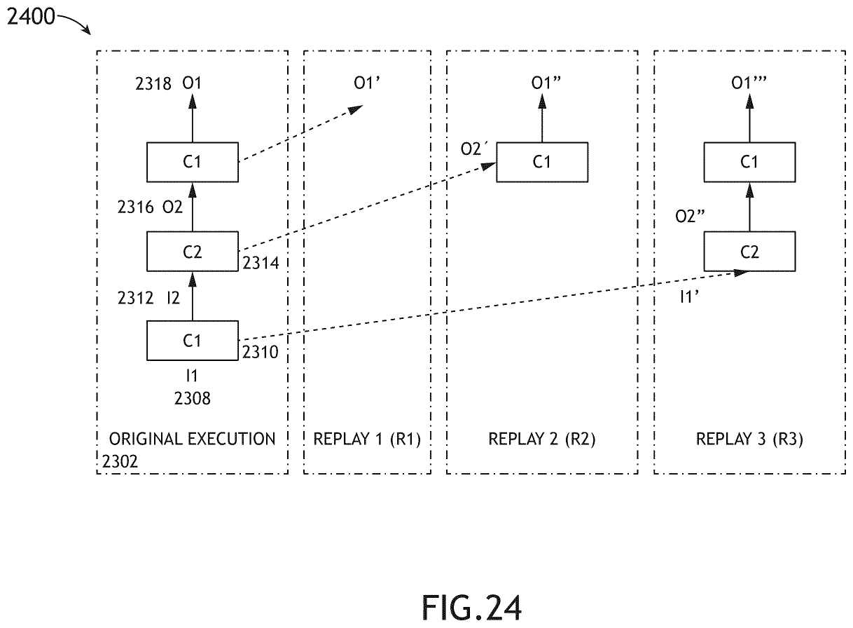

FIG. 24 illustrates an execution tree 2400 with multiple execution replays, in accordance with one or more embodiments of the present disclosure. In FIG. 24, the various replays are associated with different re-executions of the first software component (C1) and the second software component (C2).

The snapshots may also be checked out to perform an asynchronous execution. The asynchronous execution occurs when an execution is stopped before it completes and a snapshot of the execution is replayed at a later time interval. The asynchronous execution can incorporate collected data by the customized agent 116, the user, other generative components, or external systems. This data may have been collected at a time after when the execution was stopped. The asynchronous execution may allow the system's code to facilitate user input or other the input from generative AI subsystems as easily interchangeable. For example, code may be instructed to assess whether human workers, AI subsystems, or a combination of both can perform an optimization function through consideration of factors like cost, latency, and output quality.

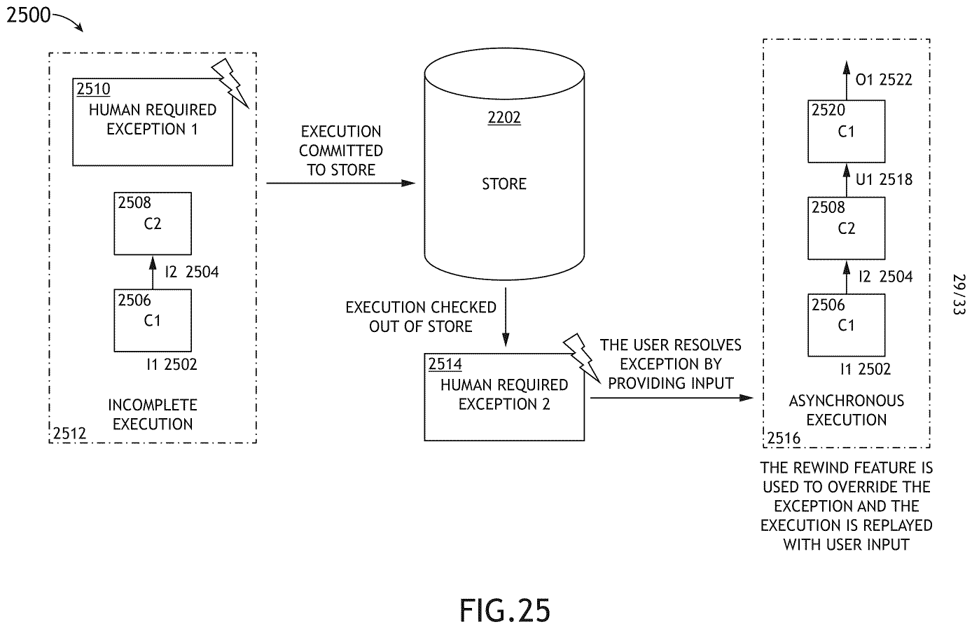

FIG. 25 illustrates a scenario 2500 involving human user input and an asynchronous execution. An incomplete execution 2512 is a type of execution that may be halted through a first human required exception 2510. The incomplete execution may include a first input (I1) 2502, a second input (I2) 2504, a first software component (C1) 2506, and a second software component (C2) 2508. A snapshot of the incomplete execution 2512 may be archived in the store 2202 following the first human required exception 2510.

When the snapshot of the incomplete execution 2512 is checked out of the store 2202, in accordance with step 1906, the snapshot may receive user input through a second human required exception 2514. This may include the user determining parameters such as the optimization target for subsequent executions, or evaluate what combination of human and AI workflows are needed to resolve the exception raised through the first human required exception 2510.

The snapshot of the incomplete execution 2512 may then be used to complete an asynchronous execution 2516. This asynchronous execution 2516 may be performed by using the rewind feature to override the first human required exception 2510. The asynchronous execution may contain all the elements of the incomplete execution, including the first input (I1) 2502, the second input (I2) 2504, the first software component (C1) 2506, and the second software component (C2) 2508. It may further include a user input 1 (U1) 2518. The user input (U1) 2518 may be information from the second human required exception 2514 that directly resolves the first human required exception 2510. The asynchronous execution 2516 may also include a third software component (C3) 2520. The third software component (C3) 2520 may incorporate the user input (U1) 2518 as an input. The asynchronous execution 2516 may also include a first output (O1) 2522. The first output (O1) 2522 may be an output of the first software component (C3) 2520.

An additional type of execution the system may perform is a distributed execution. In the distributed execution, a snapshot of the incomplete execution is distributed through the one or more computer networks. The distributed execution may then be completed on a different device than the incomplete execution.

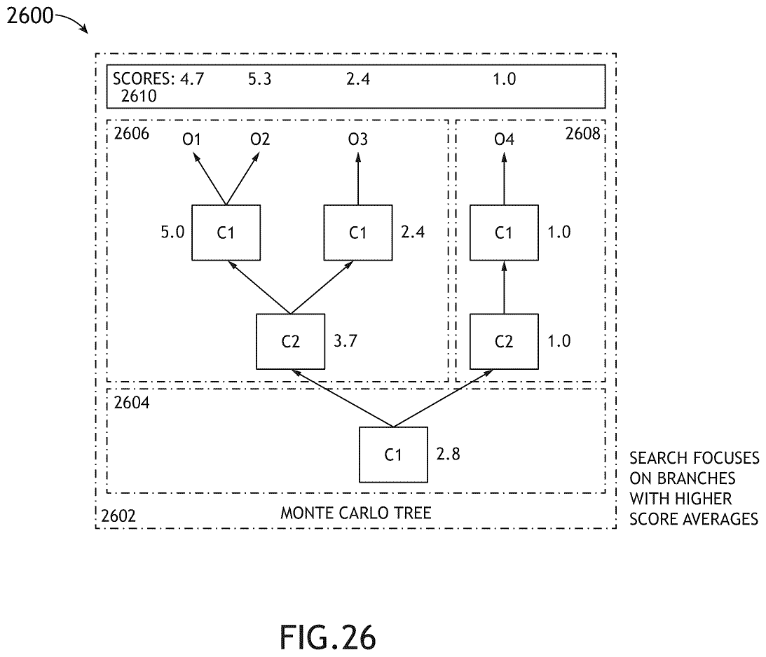

Returning to FIG. 19B, the method 1900 may include a step 1908 for providing optimization of the generative neural network using reward-based optimization techniques. As previously stated, the system provides capture and storage of snapshots of a generative software system, and to allow the ability to check out those versioned snapshots to modify them. These modifications may utilize a variety of different known algorithm types that may be automated. The system may utilize data contained in journaled executions, including human inputs and task rewards to improve the performance of the system. The task reward quantifies the success of the AI agent in achieving its objective. FIGS. 26-29 illustrate examples of some of these optimization techniques.

In some embodiments, the optimization techniques used include gradient-free techniques. These techniques do not use derivatives, and can be useful when, for example, the data is not differentiable. One example of a gradient-free technique is Bandit optimization. The technique works by experimentally replacing software components with application programming interface (API) identical components. The API identical components come from a set of candidates chosen using techniques such as Thompson sampling, UCB sampling, or A/B test.

FIG. 26 illustrates another gradient-free optimization technique, the Monte Carlo technique 2600. The Monte Carlo technique 2600 uses the replay mechanism to generate a tree 2602 of possible system executions to determine an improved output or an improved distribution of outputs. The Monte Carlo technique 2600 defines an improved output by searching the tree to focus on branches with higher score averages and prioritizes them. For example, the tree 2602 begins with the first execution 2604 in the first software component (C1) 2306. Following the first execution 2604, the model may break into a first branch 2606 and a second branch 2608. Both the first and second branch 2606, 2608 may use the output from the first execution 2604 (2.8 in this example), to generate outputs within their respective branches, using the second software component (C2) 2312.

The output of the first branch 2606 may then be compared to the output of the second branch 2608 to determine which one has the higher average score 2610 (in this example 3.7 is greater than 1.0). After the determination is made for which branch has the higher average score, the model then focuses more computational resources towards that respective branch (in this example, the second branch 2608). This process may then be repeated multiple times, generating a series of branches with respective outputs. At the end of the optimization execution, the scores 2610 from the outputs may be used to improve system components, with more weight given to the higher scores. In the example in FIG. 25, the score associated with O2 would be weighed as the most favorable. This improvement is done by using machine learning techniques to train the generative subcomponents to match the distributions encountered during the optimization execution.

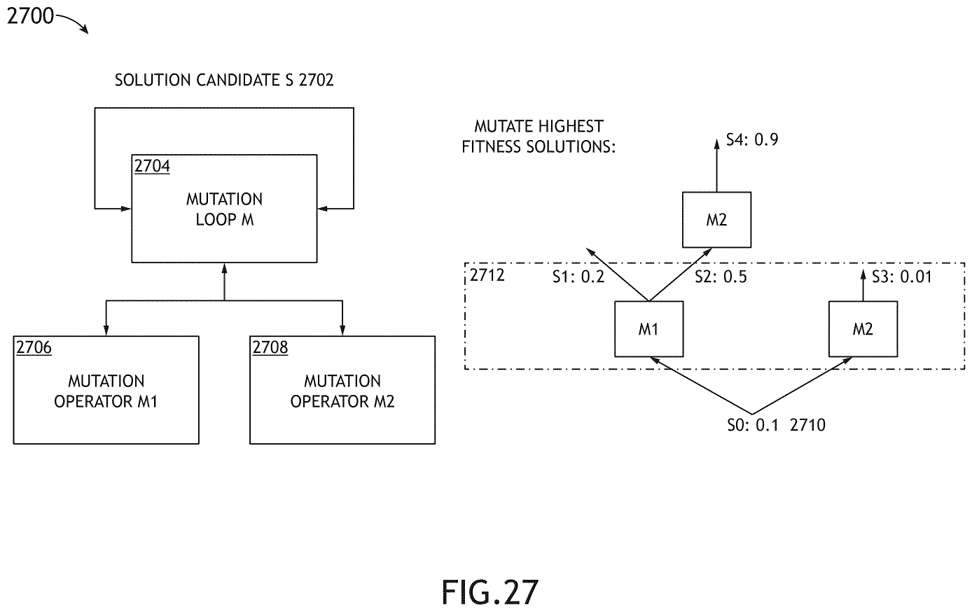

FIG. 27 illustrates an example of the operation of a genetic algorithm 2700 for generative programs, an additional gradient-free optimization technique, in accordance with one or more embodiments of the present disclosure. The genetic algorithm can be used to track and refine populations of executions in cases where the generative software used consists of iteratively and non-deterministically applying changes to potential solutions. The process used is based on natural selection, analogous to biological evolution, and is useful in processes that are discontinuous, nondifferentiable, or highly nonlinear.

In the genetic algorithm 2700, a solution candidate (S) 2702 may be randomly generated. The solution candidate (S) 2702 may then be run through a mutation loop (M) 2704. The mutation loop M 2704 scores the solution candidate (S) 2702 by assigning it an initial fitness value (S0) 2710. The genetic algorithm 2700 may then run the solution through a first (M1) 2706 and a second (M2) 2708 mutation operator. Each of the two mutation operators 2706, 2708 will generate a new generation, with a population of solution candidates (S1, S2, S3) that are also assigned respective fitness values. The algorithm will prioritize and mutate the solution candidates with the highest fitness value. For example, in FIG. 27, S2 has the highest fitness value of the new population 2712. This process will reiterate, creating new generations of populations with the genetic algorithm 2700 deferring to solutions that mutate to the highest fitness value in each sequence. The genetic algorithm 2700 will continue until the system reaches prescribed criteria for improved performance.

An additional example of a gradient-free optimization technique that may be used is a code-synthesis-based optimization. This technique optimizes a generative software system (AI agent) through application of generative code-synthesis procedure to generate new candidate components to replace existing components. This technique may draw on information from snapshots of journaled executions of previous outputs.

In some embodiments, the optimization techniques used may include gradient-based techniques. Gradient-based optimization techniques utilize derivatives, as opposed to only the function value as in gradient-free optimization techniques, to formulate performance metrics and iteratively constraint a function to achieve the performance metrics. Gradient-based approaches may include machine learning.

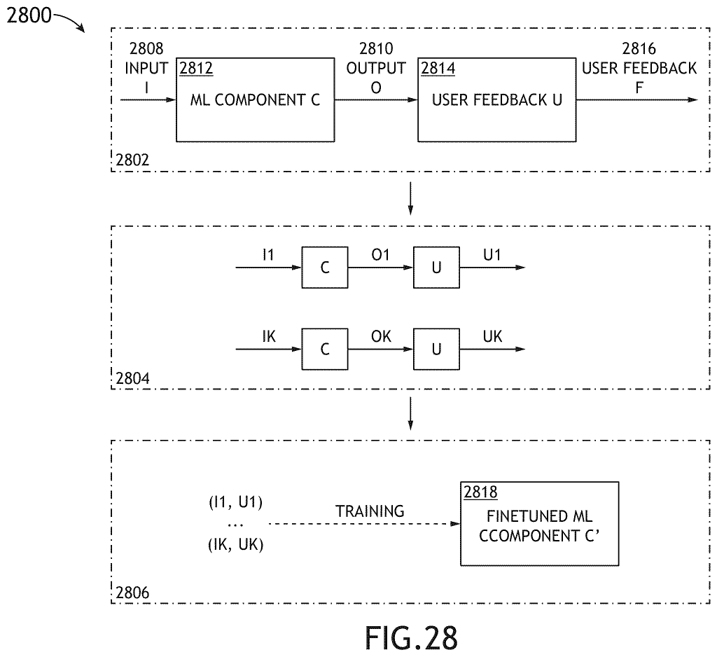

For example, a type of gradient-based optimization utilized may be a Supervised Fine-Tuning approach 2800, as illustrated in FIG. 28. The Supervised Fine-Tuning approach 2800 uses data from journaled executions along with human inputs to alter the parameters of a machine learning component to produce parameters that are more similar to a desired output dataset. The Supervised Fine-Tuning approach 2800 may include a step 2802. The step 2802 may include an input (I) 2808 into a machine learning component (C) 2812. The machine learning component (C) 2812 may then produce an output (O) 2810. The output (O) 2810 may then be provided into a user feedback module (U) 2814, where the user may provide a user feedback (F) 2816.

The Supervised Fine-Tuning approach 2800 may also include a step 2804, where the execution trace produced in the step 2802 is journaled. The step 2804 is repeated for each sampled execution trace from the step 2802. The Supervised Fine-Tuning approach 2800 may also include a step 2806, where the machine learning component is trained using the journaled executions, including the user feedback 2816, to develop a finetuned machine learning component (C′) 2818.

Another example of a gradient based-optimization technique may include reinforcement learning. In this technique, a reward signal is used to adjust parameters of the individual generative computational modules in order to achieve a higher reward. The reward signal may include reinforcement of parameter adjustments that bring the performance of the individual software components in line with desired results and may be defined from human input or through software.

An additional example of a gradient based-optimization technique may include distillation. The process involves transferring knowledge from a larger model down to a smaller model. This technique trains one generative component on the inputs and outputs of another generative component.

A further example of a gradient-based optimization technique may include gradient descent. This technique looks to minimize the errors between predicted and actual iterations. The gradient descent technique propagates parameter gradients across component boundaries of a generative system. The system then adjusts component parameters using the gradient descent technique to fit a target function to the collected data.

The combinations of gradient-based and gradient-free (e.g., non-gradient) approaches. In these techniques, searching is used in the space of generative executions to improve on the outputs of a trained component. This improvement on the outputs of the trained component subsequently improves the performance of the future searches.

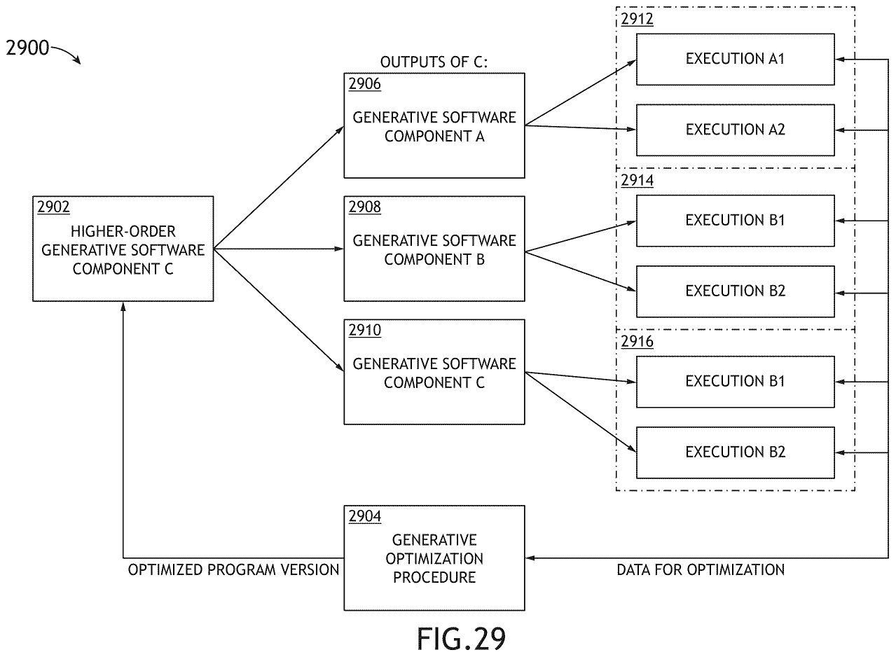

In some embodiments, the optimization techniques may include advanced optimization flows. For example, a type of advanced optimization flow is a higher-order optimization technique 2900, illustrated in FIG. 29. In this technique 2900, a higher-order generative computational module (HOC) 2902 may follow a generative optimization procedure 2904. The higher-order generative computational module (HOC) 2902, may then produce one or more generative computational modules (Generative Software Component A 2906, Generative Software Component B 2908, Generative Software Component C 2910). The generative software components (e.g., Generative Software Component A 2906, Generative Software Component B 2908, Generative Software Component C 2910) are direct outputs from the higher-order generative software component (HOC) 2902. The generative software components may then generate execution sets of generated software (Execution Set A 2912 for Generative Software Component A 2906, Execution Set B 2914 for Generative Software Component B 2908, Execution Set C 2916 for Generative Software Component C 2910). The sets of executions of generated software (e.g., Execution Set A 2912 for Generative Software Component A 2906, Execution Set B 2914 for Generative Software Component B 2908, Execution Set C 2916 for Generative Software Component C 2910) may be derived from journaled executions of the lower-order generated software systems. The sets of executions of generated software may then be used as data for the optimization of the generative optimization procedure 2904, repeating the process.

Another example of advanced optimization flows is a meta-optimization technique. In this technique, the optimization algorithms themselves can be tracked within the optimization system. Consequently, the optimization algorithms can be implemented to improve the optimization algorithms. The optimization algorithms may be of the same technique or may be of different techniques.

An additional example of advanced optimization flows is a joint human-AI optimization technique. This technique can be used to develop optimization algorithms that include both human user input and generative computational module input. The generative computational module input may come from either from the AI agent or from another generative computational module. The technique may be able to use any of the previously described optimization techniques that may be applied to joint human-AI components. The technique may be used to complete a variety of objectives, such as deciding whether to replace a human task with AI or replacing an AI task with a human user.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A system comprising:
a controller including one or more processors configured to execute program instructions stored in a memory medium causing the one or more processors to:
receive one or more tasks for a character to complete in one or more training sessions of an environment, where the character is controlled by a player, wherein the player is selectable between a human user and an agent implementing an active model by the controller;
dynamically switch the player between the human user and the agent during the one or more training sessions, wherein at least one condition for switching the player is based on an introspection metric generated by the agent, where the introspection metric is associated with at least one of a confidence of the agent or observed actions when the player is the human user;
capture observations from the character in the environment and corresponding actions of the character in the environment from the player during the one or more training sessions as experience data; and
train one or more models for the agent based on the experience data, wherein the one or more models includes the active model.

2. The system of claim 1, wherein the agent generates candidate actions based on the observations of the character in the environment when the human user is the player, wherein the introspection metric comprises a surprise metric associated with a difference between the candidate actions and actions of the human user.

3. The system of claim 1, wherein the introspection metric comprises an uncertainty metric associated with a confidence of actions by the agent when the agent is the player.

4. (canceled)

5. The system of claim 1, wherein training a particular one of the one or more models for the agent comprises:
assigning weights for the one or more training sessions associated with a particular model of the one or more models to provide weighted experience data; and
training the particular model based on the weighted experience data.

6. The system of claim 1, wherein the program instructions are configured to:
evaluate the one or more models based on one or more quality metrics; and
select the active model for the agent based on the one or more quality metrics.

7. The system of claim 6, wherein the one or more quality metrics include an estimated probability that a particular one or the one or more models could successfully complete the one or more tasks.

8-10. (canceled)

11. The system of claim 1, wherein at least one of the observations or actions available to the player in the environment are limited to a parameter space selected by the human user from a candidate set of parameters.

12. (canceled)

13. The system of claim 11, wherein the parameter space includes at least one of one or more properties of the character, a presence of one or more entities in the environment, or properties of the one or more entities.

14. The system of claim 11, wherein the parameter space further includes sensory feelers defining at least one of a spatial range, a temporal range, or a sensitivity of at least some observations available to the character in the environment.

15. The system of claim 1, wherein training one or more models for the agent based on the experience data further comprises:
converting the observations to an egocentric frame of reference of the character.

16. The system of claim 15, wherein the agent further includes a pre-processor configured to pre-process the observations to an environment independent form.

17. The system of claim 16, wherein pre-processing the observations to the environment independent form comprises:
pre-processing distances in the observations using a distance-based normalization technique.

18. A method comprising:
receiving one or more tasks for a character to complete in one or more training sessions of an environment, where the character is controlled by a player, wherein the player is selectable between a human user and an agent implementing an active model;
dynamically switching the player between the human user and the agent during the one or more training sessions, wherein at least one condition for switching the player is based on an introspection metric generated by the agent, where the introspection metric is associated with at least one of a confidence of the agent or observed actions when the player is the human user;
capturing observations from the character in the environment and corresponding actions of the character in the environment from the player during the one or more training sessions as experience data; and
training one or more models for the agent based on the experience data, wherein the one or more models includes the active model.

19. The method of claim 18, wherein the agent generates candidate actions based on the observations of the character in the environment when the human user is the player, wherein the introspection metric comprises a surprise metric associated with a difference between the candidate actions and actions of the human user.

20. The method of claim 18, wherein the introspection metric comprises an uncertainty metric associated with a confidence of actions by the agent when the agent is the player.

21. (canceled)

22. The method of claim 18, wherein training a particular model of the one or more models for the agent comprises:
assigning weights for the one or more training sessions associated with the particular model to provide weighted experience data; and
training the particular model based on the weighted experience data.

23. The method of claim 18, further comprising:
evaluating the one or more models based on one or more quality metrics; and
selecting the active model for the agent based on the one or more quality metrics.

24. The method of claim 23, wherein the one or more quality metrics include an estimated probability that a particular one of the one or more models could successfully complete the one or more tasks.

25-27. (canceled)

28. The method of claim 18, wherein at least one of the observations or actions available to the player in the environment are limited to a parameter space selected by the human user from a predefined candidate set of parameters.

29-31. (canceled)

32. The method of claim 18, wherein training one or more models for the agent based on the experience data further comprises:
converting the observations from the environment to an egocentric frame of reference of the character.

33-34. (canceled)
